(19) United States
(12) Patent Application Publication
(10) Pub. No.: US 2026/0214361 A1
(43) Pub. Date: Jul. 23, 2026

(54) PHOTOELECTRIC CONVERSION DEVICE, PHOTOELECTRIC CONVERSION SYSTEM, MOVABLE OBJECT, AND EQUIPMENT

(71) Applicant: CANON KABUSHIKI KAISHA, Tokyo (JP)

(72) Inventor: HIDEO KOBAYASHI, Tokyo (JP)

(21) Appl. No.: 19/324,437

(22) Filed: Sep. 10, 2025

Related U.S. Application Data
(63) Continuation of application No. PCT/JP2024/010425, filed on Mar. 18, 2024.

(30) Foreign Application Priority Data
Mar. 22, 2023 (JP) 2023-045425

(51) Int. Cl. H04N 25/78; H04N 25/616; H04N 25/79

(52) U.S. Cl. CPC H04N 25/78; H04N 25/79; H04N 25/616

(57) ABSTRACT

A photoelectric conversion device includes pixels arranged to form a column and each configured to output a signal based on charge generated by a photoelectric conversion unit, signal lines provided corresponding to the column and each connected to at least one of the pixels, and a column circuit connected to the signal lines. The signal lines include first and second signal lines. A first parasitic capacitance value associated with the first signal line is greater than a second parasitic capacitance value associated with the second signal line. The column circuit includes a speed-up circuit that promotes a change in a potential of the first signal line so as to reduce a difference between a settling time of the potential of the first signal line and a settling time of a potential of the second signal line caused by a difference between the first and the second parasitic capacitance values.

### CROSS-REFERENCE TO RELATED APPLICATIONS

This application is a Continuation of International Patent Application No. PCT/JP2024/010425, filed Mar. 18, 2024, which claims the benefit of Japanese Patent Application No. 2023-045425, filed Mar. 22, 2023, both of which are hereby incorporated by reference herein in their entirety.

### BACKGROUND

### Field of the Technology

The present disclosure relates to a photoelectric conversion device, a photoelectric conversion system, a movable object, and an equipment.

### Description of the Related Art

In a photoelectric conversion device such as a CMOS image sensor, it is required to suppress the influence of parasitic capacitance associated with a signal line from which a pixel signal is output from the viewpoint of, for example, increasing an operation speed. Japanese Patent Laid-Open No. 2019-030002 describes a solid-state imaging device configured to reduce the influence of parasitic capacitance accompanied by a signal line by connecting a negative capacitance circuit to the signal line.

However, in the technique described in Japanese Patent Laid-Open No. 2019-030002, no particular consideration is given to the case where the signal line arranged in each column includes a plurality of signal lines, and the influence of the parasitic capacitance accompanied by the signal line cannot necessarily be appropriately reduced.

### SUMMARY

The present disclosure is directed to a technique for reducing the influence of parasitic capacitance associated with a signal line in a photoelectric conversion device in which a plurality of signal lines is arranged corresponding to pixels in one column.

According to an aspect of the present disclosure, there is provided a solid-state imaging device including: a plurality of pixels arranged to form a column and each of which outputs a signal based on a charge generated in a photoelectric conversion unit; a plurality of signal lines provided corresponding to the column and each of which is connected to at least one of the plurality of pixels; and a column circuit connected to the plurality of signal lines, wherein the plurality of signal lines include a first signal line and a second signal line, and a first capacitance value of a parasitic capacitance associated with the first signal line is larger than a second capacitance value of a parasitic capacitance associated with the second signal line, there is provided the photoelectric conversion device in which the column circuit includes a speed-up circuit that promotes a change in the potential on the first signal line so as to reduce a difference in the static time of the potential caused by a difference between the first capacitance value and the second capacitance value.

Features of the present disclosure will become apparent from the following description of embodiments with reference to the attached drawings.

### BRIEF DESCRIPTION OF THE DRAWINGS

FIG. 1 is a block diagram illustrating a schematic configuration of a photoelectric conversion device according to a first embodiment.

FIG. 2 is a circuit diagram illustrating a configuration example of a pixel in the photoelectric conversion device according to the first embodiment.

FIG. 3 is a circuit diagram illustrating a configuration example of a column circuit in the photoelectric conversion device according to the first embodiment.

FIG. 4 is a circuit diagram illustrating a configuration example of a current source circuit in the photoelectric conversion device according to the first embodiment.

FIG. 5 is a circuit diagram illustrating a configuration example of a bias circuit in the photoelectric conversion device according to the first embodiment.

FIG. 6 is a circuit diagram illustrating another configuration example of the bias circuit in the photoelectric conversion device according to the first embodiment.

FIG. 7 is a circuit diagram illustrating a configuration example of an amplifier of a negative capacitance circuit in the photoelectric conversion device according to the first embodiment.

FIG. 8A and FIG. 8B are schematic diagrams illustrating configuration examples of the photoelectric conversion device according to the first embodiment.

FIG. 9 is a timing chart illustrating a method of driving the photoelectric conversion device according to the first embodiment.

FIG. 10A and FIG. 10B are diagrams illustrating an example of arrangement of signal lines and interconnections in the photoelectric conversion device according to the first embodiment.

FIG. 11A, FIG. 11B, FIG. 11C, FIG. 11D, FIG. 11E, and FIG. 11F are cross-sectional views illustrating other arrangement examples of the signal lines and the interconnections in the photoelectric conversion device according to the first embodiment.

FIG. 12 is a circuit diagram illustrating a configuration example of a column circuit in a photoelectric conversion device according to a second embodiment.

FIG. 13 is a timing chart illustrating a method of driving the photoelectric conversion device according to the second embodiment.

FIG. 14 is a circuit diagram illustrating a configuration example of a column circuit in a photoelectric conversion device according to a third embodiment.

FIG. 15 is a circuit diagram illustrating a configuration example of a column circuit in a photoelectric conversion device according to a fourth embodiment.

FIG. 16 is a circuit diagram illustrating a configuration example of a column circuit in a photoelectric conversion device according to a fifth embodiment.

FIG. 17A, FIG. 17B, FIG. 17C, and FIG. 17D are cross-sectional views illustrating configuration examples of a capacitor in the photoelectric conversion device according to the fifth embodiment.

FIG. 18 is a circuit diagram illustrating another configuration example of the photoelectric conversion device according to the fifth embodiment.

FIG. 19 is a circuit diagram illustrating a configuration example of an amplifier of a negative capacitance circuit in the photoelectric conversion device according to the fifth embodiment.

FIG. 20 and FIG. 21 are schematic diagrams illustrating layout examples of a current source circuit and the negative capacitance circuit in the photoelectric conversion device according to the fifth embodiment.

FIG. 22A and FIG. 22B are schematic diagrams illustrating a configuration example of a photoelectric conversion device according to a sixth embodiment.

FIG. 23A and FIG. 23B are schematic diagrams illustrating a configuration example of a photoelectric conversion device according to a seventh embodiment.

FIG. 24 is a circuit diagram illustrating a configuration example of a photoelectric conversion device according to an eighth embodiment.

FIG. 25A and FIG. 25B are diagrams illustrating an arrangement example of signal lines and interconnections in the photoelectric conversion device according to the eighth embodiment.

FIG. 26 and FIG. 27 are circuit diagrams illustrating other configuration examples of the photoelectric conversion device according to the eighth embodiment.

FIG. 28 is a circuit diagram illustrating a configuration example of a photoelectric conversion device according to a ninth embodiment.

FIG. 29 and FIG. 31 are circuit diagrams illustrating other configuration examples of the photoelectric conversion device according to the ninth embodiment.

FIG. 30A and FIG. 30B are diagrams illustrating an arrangement example of signal lines and interconnections in the photoelectric conversion device according to the ninth embodiment.

FIG. 32 is a circuit diagram illustrating a configuration example of a pixel in a photoelectric conversion device according to a modification of the embodiments.

FIG. 33 is a circuit diagram illustrating a configuration example of a current source circuit in a photoelectric conversion device according to a modification of the embodiments.

FIG. 34 is a circuit diagram illustrating a configuration example of a column circuit in a photoelectric conversion device according to a modification of the embodiments.

FIG. 35 is a block diagram illustrating a schematic configuration of a photoelectric conversion system according to a tenth embodiment.

FIG. 36A is a diagram illustrating a configuration example of a photoelectric conversion system according to an eleventh embodiment.

FIG. 36B is a diagram illustrating a configuration example of a movable object according to the eleventh embodiment.

FIG. 37 is a block diagram illustrating a schematic configuration of an equipment according to a twelfth embodiment.

Preferred embodiments of the present disclosure will now be described in detail in accordance with the accompanying drawings.

### First Embodiment

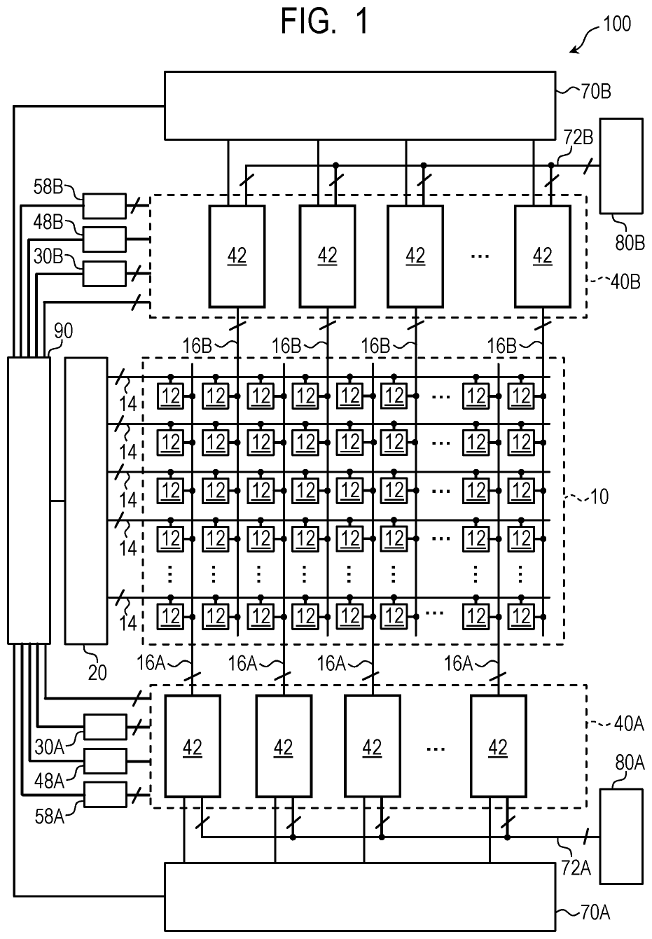

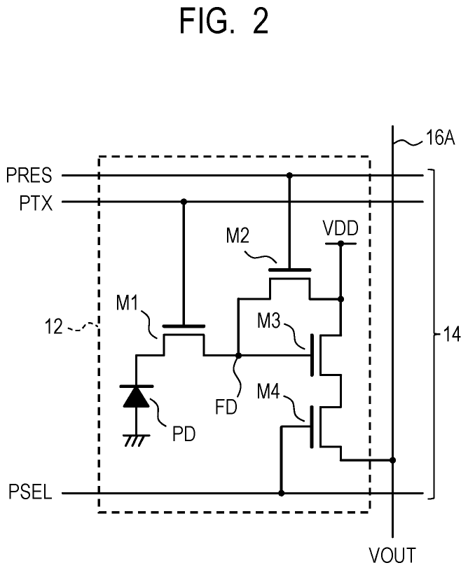

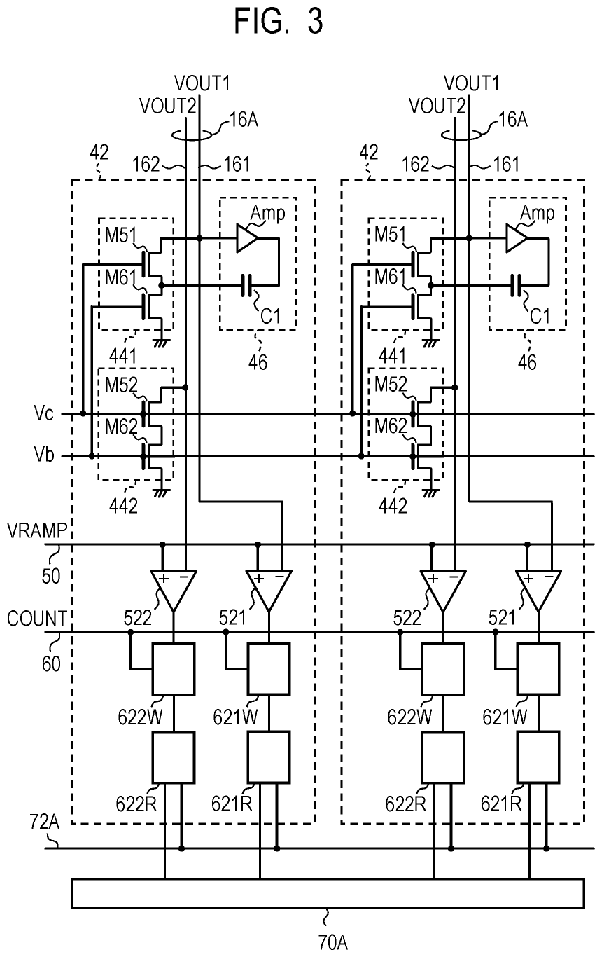

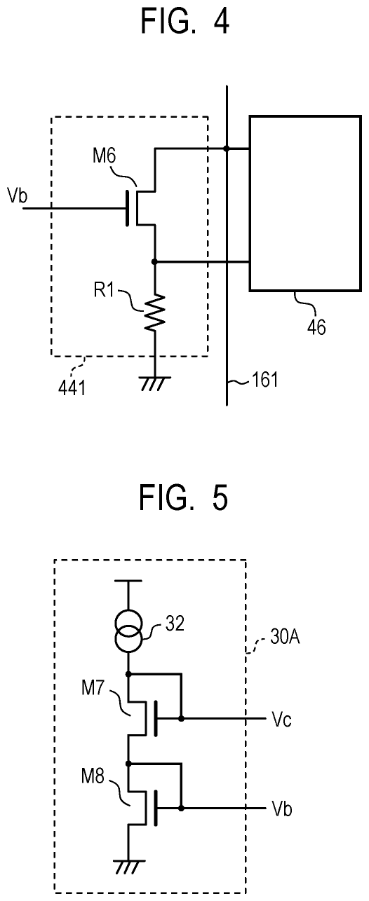

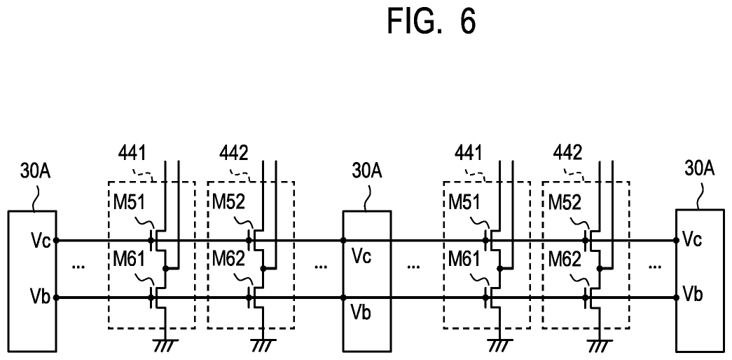

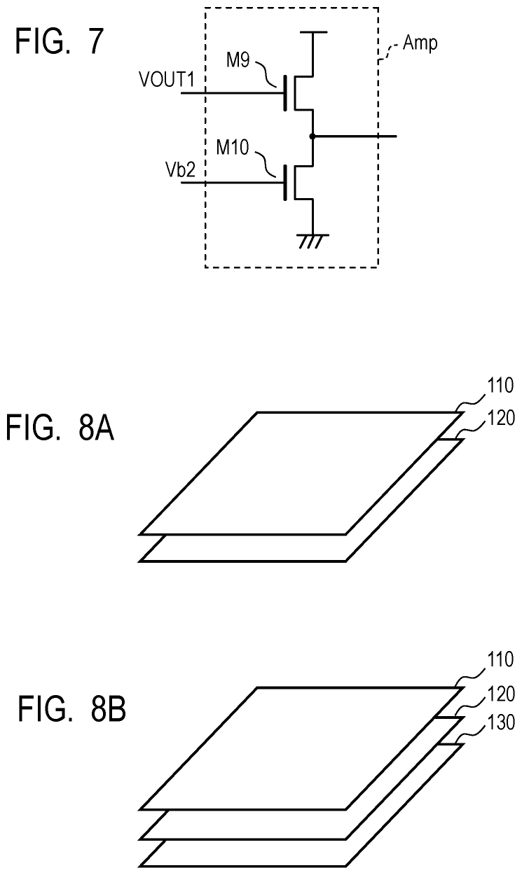

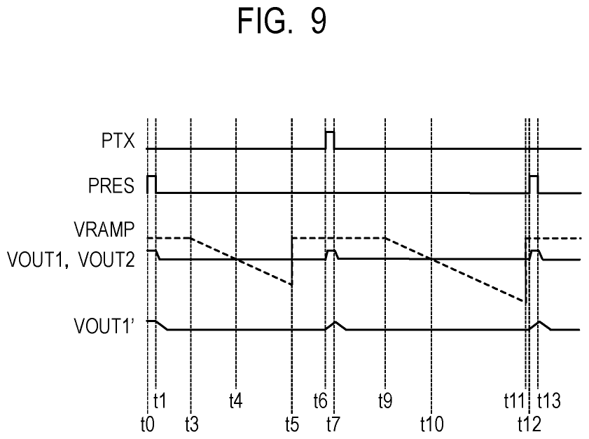

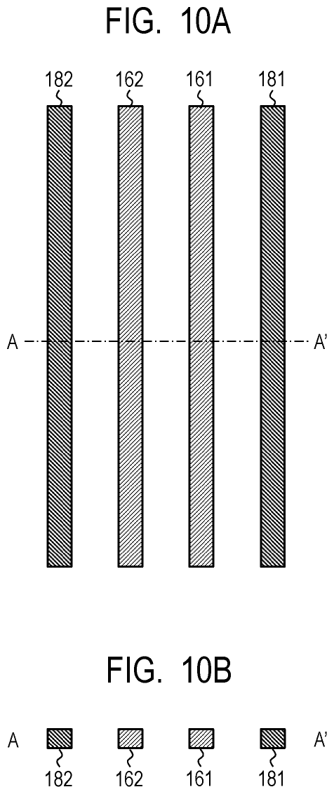

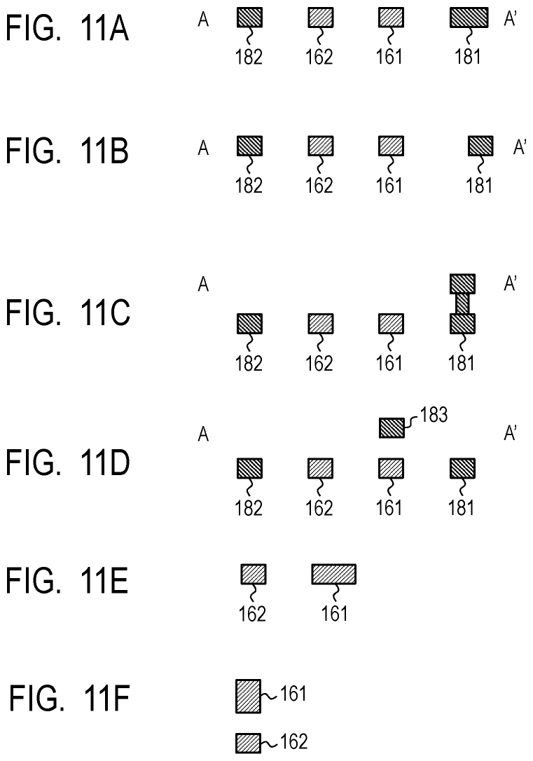

A photoelectric conversion device and a method of driving the same according to a first embodiment will be described with reference to FIG. 1 to FIG. 11F. FIG. 1 is a block diagram illustrating a schematic configuration of a photoelectric conversion device according to the present embodiment. FIG. 2 is a circuit diagram illustrating a configuration example of a pixel in the photoelectric conversion device according to the present embodiment. FIG. 3 is a circuit diagram illustrating a configuration example of a column circuit in the photoelectric conversion device according to the present embodiment. FIG. 4 is a circuit diagram illustrating a configuration example of a current source circuit in the photoelectric conversion device according to the present embodiment. FIG. 5 is a circuit diagram illustrating a configuration example of a bias circuit in the photoelectric conversion device according to the present embodiment. FIG. 6 is a circuit diagram illustrating another configuration example of the bias circuit in the photoelectric conversion device according to the present embodiment. FIG. 7 is a circuit diagram illustrating a configuration example of an amplifier of a negative capacitance circuit in the photoelectric conversion device according to the present embodiment. FIG. 8A and FIG. 8B are schematic diagrams illustrating a configuration example of the photoelectric conversion device according to the present embodiment. FIG. 9 is a timing chart illustrating a method of driving the photoelectric conversion device according to the present embodiment. FIG. 10A to FIG. 11F are diagrams illustrating arrangement examples of signal lines and interconnections in the photoelectric conversion device according to the present embodiment.

As illustrated in FIG. 1, the photoelectric conversion device 100 according to the present embodiment includes a pixel array unit 10, a vertical scanning circuit 20, bias circuits 30A and 30B, readout circuits 40A and 40B, reference signal generation circuits 48A and 48B, and counter circuits 58A and 58B. The photoelectric conversion device 100 further includes horizontal scanning circuits 70A and 70B, output circuits 80A and 80B, and a control circuit 90.

The pixel array unit 10 is provided with a plurality of pixels 12 arranged in a matrix over a plurality of rows and a plurality of columns. Each pixel 12 includes a photoelectric conversion unit including a photoelectric conversion element such as a photodiode and outputs a pixel signal according to the amount of incident light. The number of rows and the number of columns of the pixel array arranged in the pixel array unit 10 are not particularly limited. In addition to effective pixels that output pixel signals according to the amount of incident light, the pixel array unit 10 may include optical black pixels in which photoelectric conversion units are shielded from light, dummy pixels that do not output signals, and the like. A specific configuration of the pixel 12 will be described later.

In each row of the pixel array unit 10, a control line 14 is arranged so as to extend in a first direction (lateral direction in FIG. 1). Each of the control lines 14 is connected to the pixels 12 arranged in the first direction on the corresponding row and forms a signal line common to these pixels 12. The first direction in which the control lines 14 extend may be referred to as a row direction or a horizontal direction. The control line 14 is connected to the vertical scanning circuit 20. Each of the control lines 14 may include a plurality of signal lines.

In each column of the pixel array unit 10, an output line group 16A or an output line group 16B is arranged so as to extend in a second direction (vertical direction in FIG. 1) intersecting the first direction. The output line group 16A and the output line group 16B are alternately arranged in each column. For example, the output line group 16A is arranged in an odd-numbered column, and the output line group 16B is arranged in an even-numbered column. Each of the output line groups 16A and 16B includes a plurality of signal lines. The pixels 12 arranged in each column are connected to any of a plurality of signal lines of the corresponding column. In the present embodiment, each of the output line groups 16A and 16B includes two signal lines (signal lines 161 and 162 to be described later). The output line group 16A is connected to the readout circuit 40A. The output line group 16B is connected to the readout circuit 40B.

The vertical scanning circuit 20 is a control circuit having a function of generating a control signal for driving the pixels 12 in response to a control signal from the control circuit 90 and outputting the generated control signal to the pixels 12 via the control lines 14. A logic circuit such as a shift register or an address decoder may be used as the vertical scanning circuit 20. The vertical scanning circuit 20 sequentially outputs control signals to the control lines 14 of each row and sequentially drives the pixels 12 of the pixel array unit 10 in units of rows. The signals read out from the pixels 12 in units of rows are input to the readout circuit 40A or the readout circuit 40B via the output line group 16A or the output line group 16B arranged in each column of the pixel array unit 10.

The bias circuit 30A is a circuit that supplies a predetermined bias voltage to a current source (current source circuits 441 and 442 described later) (not illustrated in FIG. 1) included in the column circuit 42 of each column of the readout circuit 40A. Similarly, the bias circuit 30B is a circuit that supplies a predetermined bias voltage to a current source (current source circuits 441 and 442) (not illustrated in FIG. 1) included in the column circuit 42 of each column of the readout circuit 40B.

The readout circuit 40A includes a plurality of column circuits 42 corresponding to the number of columns in which the output line group 16A is arranged. Each of the column circuits 42 of the readout circuit 40A is connected to the output line group 16A of the corresponding column. Similarly, the readout circuit 40B includes a plurality of column circuits 42 corresponding to the number of columns in which the output line group 16B is arranged. Each of the column circuits 42 of the readout circuit 40B is connected to the output line group 16B of the corresponding column. The column circuit 42 is a processing circuit that performs predetermined processing on the pixel signal read out from the pixel 12 in the corresponding column. Examples of the processing performed by the column circuit 42 include signal processing such as amplification processing and analog-to-digital conversion (AD conversion) processing. The column circuit 42 includes a signal holding circuit (memory) for holding the processed pixel signal.

The reference signal generation circuit 48A is connected to the readout circuit 40A. The reference signal generation circuit 48A has a function of generating a reference signal used for the AD conversion in response to a control signal from the control circuit 90 and outputting the reference signal to the readout circuit 40A. Similarly, the reference signal generation circuit 48B is connected to the readout circuit 40B. The reference signal generation circuit 48B has a function of generating a reference signal used for the AD conversion in response to a control signal from the control circuit 90 and outputting the reference signal to the readout circuit 40B.

The reference signal used for the AD conversion may have a predetermined amplitude according to the range of the pixel signal and may be a signal whose signal level changes with time. Although the reference signal is not particularly limited, for example, a ramp signal in which the signal level monotonically increases or monotonically decreases with time may be applied. Note that the change in the signal level does not necessarily have to be continuous and may be stepwise. In addition, the change in the signal level does not necessarily need to be linear with respect to time and may be curved with respect to time (for example, a sine wave or a cosine wave).

The counter circuit 58A is connected to the readout circuit 40A. The counter circuit 58A has a function of performing a count operation in accordance with a control signal from the control circuit 90 and outputting a count signal indicating the count value to the readout circuit 40A. The counter circuit 58A starts a count operation in synchronization with a timing at which a change in the signal level of the reference signal supplied from the reference signal generation circuit 48A starts. Similarly, the counter circuit 58B is connected to the readout circuit 40B. The counter circuit 58B has a function of performing a count operation in accordance with a control signal from the control circuit 90 and outputting a count signal indicating the count value to the readout circuit 40B. The counter circuit 58B starts a count operation in synchronization with a timing at which a change in the signal level of the reference signal supplied from the reference signal generation circuit 48B starts.

The horizontal scanning circuit 70A is a control circuit having a function of generating a control signal for reading out the pixel signal from the column circuit 42 of the readout circuit 40A in response to a control signal from the control circuit 90 and outputting the control signal to the readout circuit 40A. The horizontal scanning circuit 70A sequentially scans the column circuits 42 of the readout circuit 40A and sequentially outputs the pixel signals held therein to the output circuit 80A via the horizontal output line 72A. Similarly, the horizontal scanning circuit 70B is a control unit having a function of generating a control signal for reading out the pixel signal from the column circuit 42 of the readout circuit 40B in response to a control signal from the control circuit 90 and outputting the control signal to the readout circuit 40B. The horizontal scanning circuit 70B sequentially scans the column circuits 42 of the readout circuit 40B and sequentially outputs the pixel signals held therein to the output circuit 80B via the horizontal output line 72B. A logic circuit such as a shift register or an address decoder may be used for the horizontal scanning circuits 70A and 70B.

The output circuit 80A includes is a processing circuit that performs predetermined signal processing on the pixel signal of a column selected by the horizontal scanning circuit 70A and outputs processed pixel data and may include a buffer amplifier, a differential amplifier, and the like. Similarly, the output circuit 80B is a processing circuit that performs predetermined signal processing on the pixel signal of a column selected by the horizontal scanning circuit 70B and outputs processed pixel data and may include a buffer amplifier, a differential amplifier, and the like. Examples of the signal processing performed by the output circuits 80A and 80B include correction processing by correlated double sampling (CDS), amplification processing, and the like.

The control circuit 90 is a control circuit for generating control signals for controlling operations of the vertical scanning circuit 20, the readout circuits 40A and 40B, the reference signal generation circuits 48A and 48B, the counter circuits 58A and 58B, the horizontal scanning circuits 70A and 70B, and the like and outputting the generated control signals to these functional blocks. At least a part of the control signals for controlling the operations of these functional blocks may be supplied from the outside of the photoelectric conversion device 100.

FIG. 1 illustrates an example in which two readout circuit blocks, a readout circuit block including the readout circuit 40A, the horizontal scanning circuit 70A, the output circuit 80A, and the like, and a readout circuit block including the readout circuit 40B, the horizontal scanning circuit 70B, the output circuit 80B, and the like, are provided. However, the number of readout circuit blocks is not necessarily two and may be one.

Each of the pixels 12 included in the pixel array unit 10 may include, for example, as illustrated in FIG. 2, a photoelectric conversion element PD, a transfer transistor M1, a reset transistor M2, an amplifier transistor M3, and a select transistor M4.

The photoelectric conversion element PD is, for example, a photodiode having an anode connected to a ground voltage line and a cathode connected to a source of the transfer transistor M1. A drain of the transfer transistor MI is connected to a source of the reset transistor M2 and a gate of the amplifier transistor M3. The node FD to which the drain of the transfer transistor M1, the source of the reset transistor M2, and the gate of the amplifier transistor M3 are connected is called a floating diffusion. The floating diffusion includes a capacitance component (floating diffusion capacitance) and has a function as a charge holding portion. The floating diffusion capacitance may include a gate capacitance of the transistor, a p-n junction capacitance, an interconnection capacitance, and the like. A drain of the reset transistor M2 and a drain of the amplifier transistor M3 are connected to a node to which a power supply voltage (voltage VDD) is supplied. A source of the amplifier transistor M3 is connected to a drain of the select transistor M4. A source of the select transistor M4 is connected to the output line group 16A (or the output line group 16B).

In the case of the pixel configuration of FIG. 2, the control line 14 of each row includes three signal lines including a signal line connected to a gate of the transfer transistor M1, a signal line connected to a gate of the reset transistor M2, and a signal line connected to a gate of the select transistor M4. A control signal PTX is supplied from the vertical scanning circuit 20 to the gate of the transfer transistor M1. A control signal PRES is supplied from the vertical scanning circuit 20 to the gate of the reset transistor M2. A control signal PSEL is supplied from the vertical scanning circuit 20 to the gate of the select transistor M4. In a case where each transistor is formed of an n-channel MOS transistor, the corresponding transistor is turned on when a high-level control signal is supplied from the vertical scanning circuit 20. When a low-level control signal is supplied from the vertical scanning circuit 20, the corresponding transistor is turned off.

The present embodiment will be described on the assumption that electrons among electron-hole pairs generated in the photoelectric conversion element PD by light incidence are used as signal charge. When electrons are used as the signal charge, each transistor constituting the pixel 12 may be formed of an n-channel MOS transistor. However, the signal charge is not limited to electrons, and holes may be used as the signal charge. When holes are used as the signal charge, the conductivity type of each transistor may be opposite to that described in the present embodiment. The names of the source and the drain of the MOS transistor may vary depending on the conductivity type of the transistor or the function of the transistor focused on. Some or all of the names of the source and the drain used in the present embodiment may be referred to as reverse names. In this specification, one of the source and the drain may be referred to as a first main node, the other of the source and the drain may be referred to as a second main node, and the gate may be referred to as a control node.

The photoelectric conversion element PD converts (photoelectrically converts) the incident light into electric charge of an amount corresponding to the amount of the incident light and accumulates the generated charge. The transfer transistor M1 transfers the charge held by the photoelectric conversion element PD to the node FD by turning on. The charge transferred from the photoelectric conversion element PD is held in the capacitance component (floating diffusion capacitance) of the node FD. As a result, the node FD has a potential corresponding to the amount of charge transferred from the photoelectric conversion element PD by charge-voltage conversion by the floating diffusion capacitance.

The select transistor M4 connects the amplifier transistor M3 to the output line group 16A (or the output line group 16B) by turning on. The amplifier transistor M3 has a configuration in which a voltage VDD is supplied to the drain and a bias current is supplied to the source from a current source (a current source circuit described later) (not illustrated in FIG. 1) via the select transistor M4 and constitutes an amplification unit (a source follower circuit) having the gate as an input node. Accordingly, the amplifier transistor M3 outputs a signal based on the potential of the node FD to the output line group 16A (or the output line group 16B) via the select transistor M4. In this sense, the amplifier transistor M3 and the select transistor M4 constitutes an output unit that outputs the pixel signal according to the amount of charge held in the node FD.

The reset transistor M2 has a function of controlling supply of a voltage (voltage VDD) for resetting the node FD as the charge holding portion to the FD node. The reset transistor M2 resets the node FD to a voltage corresponding to the voltage VDD by turning on.

FIG. 3 illustrates two of the plurality of column circuits 42 constituting the readout circuit 40A. As illustrated in, e.g., FIG. 3, each of the column circuits 42 constituting the readout circuit 40A may include current source circuits 441 and 442, a negative capacitance circuit 46, comparison circuits 521 and 522, and memories 621W, 621R, 622W, and 622R.

The current source circuit 441 functions as a load current source of the amplifier transistor M3 of the pixel 12 and may include, for example, n-channel transistors M51 and M61. The transistor M51 functions as a cascode transistor, and the transistor M61 functions as a current source transistor. A drain of the transistor M51 is connected to the signal line 161. A source of the transistor M51 is connected to a drain of the transistor M61. A source of the transistor M61 is connected to the ground voltage line (fixed voltage node). A voltage Vc is supplied from the bias circuit 30A to a gate of the transistor M51. A voltage Vb is supplied from the bias circuit 30A to a gate of the transistor M61.

The current source circuit 442 functions as a load current source of the amplifier transistor M3 of the pixel 12 and may include, for example, n-channel transistors M52 and M62. The transistor M52 functions as a cascode transistor, and the transistor M62 functions as a current source transistor. A drain of the transistor M52 is connected to the signal line 162. A source of the transistor M52 is connected to a drain of the transistor M62. A source of the transistor M62 is connected to the ground voltage line (fixed voltage node). The voltage Vc is supplied from the bias circuit 30A to a gate of the transistor M52. The voltage Vb is supplied from the bias circuit 30A to a gate of the transistor M62.

The current source circuit 441 and the current source circuit 442 may include a current source transistor and a resistor. In this case, in the current source circuit 441, as illustrated in, e.g., FIG. 4, a drain of the transistor M6 may be connected to the signal line 161, a source of the transistor M6 may be connected to one terminal of the resistor R1, and the other terminal of the resistor R1 may be connected to the ground voltage line (fixed voltage node). An input node of the negative capacitance circuit 46 may be connected to the drain of the transistor M6, and an output node of the negative capacitance circuit 46 may be connected to a connection node between the source of the transistor M6 and the resistor R1. In the current source circuit 442, the drain of the transistor M6 may be connected to the signal line 162, the source of the transistor M6 may be connected to one terminal of the resistor R1, and the other terminal of the resistor R1 may be connected to the ground voltage line. The voltage Vb is supplied from the bias circuit 30A to a gate of the transistor M6 of each of the current source circuits 441 and 442.

However, in a case where the circuit configuration of FIG. 4 is applied to the current source circuits 441 and 442, the current value of the transistor M6 may change when the potential of the signal line 161 changes and a current flows through the capacitor C1. Accordingly, since the source potential of the transistor M6 fluctuates, the potential of an interconnection connected to the transistor M6 easily fluctuates, which may cause interference between columns. From such a viewpoint, it is more preferable that the output node of the negative capacitance circuit 46 is connected to the drain side of the transistor M6 as in the circuit configuration of FIG. 3 instead of the source side of the transistor M6 functioning as a current source.

As illustrated in, e.g., FIG. 5, the bias circuit 30A may include a current source 32 and n-channel transistors M7 and M8. One node of the current source 32 is connected to a power supply voltage line. The other node of the current source 32 is connected to a drain and a gate of the transistor M7. A source of the transistor M7 is connected to a drain and a gate of the transistor M8. A source of the transistor M8 is connected to the ground voltage line. A connection node between the drain and the gate of the transistor M7 serves as a node for supplying the voltage Vc, and a connection node between the drain and the gate of the transistor M8 serves as a node for supplying the voltage Vb. The voltages Vb and Vc are determined by the current value of the current source 32 and the threshold voltages and sizes of the transistors M7 and M8.

As illustrated in, e.g., FIG. 6, a plurality of bias circuits 30A may be connected in parallel and may be arranged between columns at predetermined intervals. By connecting the plurality of bias circuits 30A in parallel, fluctuations in the voltages Vb and Vc may be suppressed, and interference between columns may be suppressed.

The negative capacitance circuit 46 has a function as a speed-up circuit that promotes a transient change in the potential in the output line group 16A and may include, for example, an amplifier Amp and a capacitor C1. An input node of the amplifier Amp is connected to the signal line 161. An output node of the amplifier Amp is connected to one terminal of the capacitor C1. The other terminal of the capacitor C1 is connected to a connection node between the source of the transistor M51 and the drain of the transistor M61.

As illustrated in, e.g., FIG. 7, the amplifier Amp may be configured by a source follower circuit including an n-channel transistor M9 and a transistor M10. In the circuit illustrated in FIG. 7, the transistor M9 is an input transistor, and the transistor M10 is a current source transistor. A drain of the transistor M9 is connected to the power supply voltage line, a source of the transistor M9 is connected to a drain of the transistor M10, and a source of the transistor M10 is connected to the ground voltage line. A voltage VOUT1 output from the pixel 12 to the signal line 161 is supplied to a gate of the transistor M9. A bias voltage Vb2 is supplied to a gate of the transistor M10. The output node of the amplifier Amp, which is a connection node between the source of the transistor M9 and the drain of the transistor M10, is connected to the one terminal of the capacitor C1. When the gain of the amplifier Amp is A and the capacitance value of the capacitor C1 is C, the negative capacitance circuit 46 contributes as a negative capacitance of −A×C under a certain condition.

The comparison circuit 521 includes two input nodes (a non-inverting input node (+) and an inverting input node (−)) to which two signals to be compared are input, and one output node from which a signal indicating a comparison result is output, and the comparison circuit 521 may be comprised of, for example, a differential amplifier circuit. One input node (inversion input node) of the comparison circuit 521 is connected to the signal line 161, and the voltage VOUT1 which is an output signal of the pixel 12 is input via the signal line 161. The other input node (non-inverting input node) of the comparison circuit 521 is connected to a reference signal line 50. A reference signal VRAMP is input to the other input node of the comparison circuit 521 from the reference signal generation circuit 48A via the reference signal line 50.

The memory 621W has two input nodes and one output node. The memory 621R has two input nodes and one output node. One input node of the memory 621W is connected to the output node of the comparison circuit 521. The other input node of the memory 621W is connected to a count signal line 60. A count signal COUNT is input to the other input node of the memory 621W from the counter circuit 58A via the count signal line 60. One input node of the memory 621R is connected to the output node of the memory 621W. The other input node of the memory 621R is connected to the horizontal scanning circuit 70A. The output node of the memory 621R is connected to the horizontal output line 72A.

The comparison circuit 521 compares the level of the voltage VOUT1 output from the signal line 161 with the level of the reference signal VRAMP supplied from the reference signal line 50 and outputs a signal according to the comparison result. For example, the comparison circuit 521 outputs a high-level signal when the level of the reference signal VRAMP is lower than the level of the voltage VOUT1. When the level of the reference signal VRAMP is higher than the level of the voltage VOUT1, the comparison circuit 521 outputs a low-level signal. The relationship between the magnitudes of the input signals and the level of the output signal may be reversed.

The memory 621W holds the count value indicated by the count signal COUNT supplied from the counter circuit 58A at the timing when the level of the output node of the comparison circuit 521 is inverted, as digital data of the pixel signal. The memory 621R holds digital data of the pixel signal transferred from the memory 621W. The digital data held in the memory 621R is sequentially transferred to the output circuit 80A via the horizontal output line 72A for each column in accordance with a control signal supplied from the horizontal scanning circuit 70A. By providing the memory 621R in the subsequent stage of the memory 621W, the AD conversion processing may be performed in parallel with the transfer operation to the output circuit 80A.

Instead of providing the counter circuit 58A, the memory 621W of the column circuit 42 may have a function of the counter circuit. In this case, the memory 621W of the column circuit 42 of each column receives the common clock signal output from the control circuit 90 and counts the pulses of the clock signal. The count value at the timing when the level of the output signal of the comparison circuit 521 is inverted is digital data held in the memory 621W.

The configurations and operations of the comparison circuit 522, the memory 622W, and the memory 622R are similar to those of the comparison circuit 521, the memory 621W, and the memory 621R, except that one input node (inverted input node) of the comparison circuit 521 is connected to the signal line 162. By providing the two signal lines 161 and 162 in each column, signals of the pixels 12 in two rows may be simultaneously read out. In the configuration illustrated in FIG. 3, one column circuit 42 includes two AD conversion circuits. The first AD conversion circuit, which is one of the two AD conversion circuits, includes the comparison circuit 521, a memory 621W, and the memory 621R. The second AD conversion circuit, which is another one of the two AD conversion circuits, includes the comparison circuit 522, the memory 622W, and the memory 622R. The first AD conversion circuit converts the signal output from the pixel 12 via the signal line 161 into a digital signal. On the other hand, the second AD conversion circuit converts the signal output from the pixel 12 via the signal line 162 into a digital signal.

The column circuit 42 of the readout circuit 40B is the same as the column circuit 42 of the readout circuit 40A except that the column circuit 42 of the readout circuit 40A is arranged in a column different from the column in which the column circuit 42 is arranged, and thus description thereof is omitted. Hereinafter, the column circuit 42 of the readout circuit 40A will be described, but the same is applied to the column circuit 42 of the readout circuit 40B. In addition, in the following description, when the output line groups 16A and 16B, the readout circuits 40A and 40B, and the like are commonly described, A and B may not be distinguished from each other and may be referred to as the output line group 16, the readout circuit 40, and the like. In the case where a plurality of similar constituent elements is provided, serial numbers such as 1, 2, 3, . . . , and the like are given to the respective reference numerals, and these may be distinguished from each other.

The photoelectric conversion device 100 of the present embodiment may have a configuration in which all the functional blocks described above are arranged on one substrate or may have a configuration in which the functional blocks are separately formed on each substrate as a stacked type in which a plurality of substrates is stacked.

FIG. 8A is a schematic view when a pixel substrate 110 on which the pixel array unit 10 is arranged and a circuit substrate 120 on which other functional blocks are arranged are stacked. By arranging the pixel array unit 10 and the other functional blocks on different substrates, it is possible to reduce the size of the photoelectric conversion device 100 without sacrificing the area of the pixel array unit 10.

FIG. 8B is a schematic view when a pixel substrate 110 on which the pixel array unit 10 is arranged and circuit substrates 120 and 130 on which other functional blocks are arranged are stacked. Also in this case, it is possible to reduce the size of the photoelectric conversion device 100 without sacrificing the area of the pixel array unit 10.

The circuit elements constituting one functional block are not necessarily arranged on the same substrate and may be arranged on different substrates.

Next, the operation of the photoelectric conversion device according to the present embodiment will be described with reference to FIG. 9. The timing chart of FIG. 9 illustrates waveforms of the control signals PTX and PRES, the reference signal VRAMP, the voltage VOUT1 of the signal line 161, and the voltage VOUT2 of the signal line 162.

Just before time to, the control signal PSEL (not illustrated) of the row to be read out is at high-level. As a result, the select transistor M4 of each of the pixels 12 belonging to the row is turned on, and each of the pixels 12 is in a state capable of outputting a pixel signal to the output line group 16A of the corresponding column. Also, just before the time to, the control signals PTX and PRES of the row to be read out are at low-level, and the reference signal VRAMP is at a predetermined base voltage.

In a period from the time t0 to time t1, the vertical scanning circuit 20 controls the control signal PRES of the row to be read out to high-level. As a result, the reset transistor M2 of each of the pixels 12 belonging to the row is turned on, and the node FD is reset to a voltage corresponding to the voltage VDD. A voltage VOUT1 (a pixel signal of a reset level of the pixel 12) corresponding to the reset voltage of the node FD is output to each of the signal lines 161 connected to the pixels 12 of the row to be read out.

When the control signal PRES is changed from low-level to high-level at the time t0, the voltage of the node FD increases due to capacitive coupling between the gate and the source of the reset transistor M2, and the voltage VOUT1 also increases accordingly. Further, when the control signal PRES is changed from high-level to low-level at the time t1, the voltage of the node FD decreases due to the capacitive coupling between the gate and the source of the reset transistor M2, and the voltage VOUT1 also decreases accordingly. The settling of the voltage VOUT1 according to the change in the gate voltage of the reset transistor M2 takes a certain time.

At the subsequent time t3, the reference signal generation circuit 48A starts a slope operation of gradually decreasing the voltage of the reference signal VRAMP with time. The counter circuit 58A starts counting up simultaneously with the start of the slope operation and outputs a count signal COUNT indicating the count value to the column circuit 42 of each column via the count signal line 60.

The comparison circuit 521 of the column circuit 42 compares the level of the voltage VOUT1 with the level of the reference signal VRAMP. The level of the output signal of the comparison circuit 521 is inverted at a timing when the magnitude relationship between the level of the voltage VOUT1 and the level of the reference signal VRAMP changes, for example, at time t4 in FIG. 9.

The memory 621W of the column circuit 42 holds the count value indicated by the count signal COUNT output from the counter circuit 58A at the timing when the level of the output signal of the comparison circuit 521 is inverted as digital data of the pixel signal of the reset level of the pixel 12. In this way, AD conversion is performed on the pixel signal of the reset level of the pixel 12. The digital data held in the memory 621W is transferred to the memory 621R and then transferred to the output circuit 80A in accordance with a control signal from the horizontal scanning circuit 70A.

At the subsequent time t5, the reference signal generation circuit 48A resets the reference signal VRAMP to the level of the base voltage.

In a subsequent period from time t6 to time t7, the vertical scanning circuit 20 controls the control signal PTX of the row to be read out to high-level. Accordingly, the transfer transistor M1 of each of the pixels 12 belonging to the row is turned on, and the charge accumulated in the photoelectric conversion element PD during a predetermined exposure period is transferred to the node FD. Accordingly, the voltage of the node FD decreases in accordance with the amount of charge transferred from the photoelectric conversion element PD, and the voltage VOUT1 of the signal line 161 also decreases. A voltage VOUT1 (a pixel signal at the light signal level of the pixel 12) corresponding to the voltage of the node FD is output to the signal line 161. Note that FIG. 9 illustrates a waveform in a case corresponding to dark, and it is assumed that the level after the time t7 is also settled to substantially the same reset level at the time t3.

When the control signal PTX is changed from low-level to high-level at the time t6, the voltage of the node FD increases due to capacitive coupling between the gate and the drain of the transfer transistor M1, and the voltage VOUT1 also increases accordingly. Further, when the control signal PTX is changed from high-level to low-level at the time t7, the voltage of the node FD decreases due to the capacitive coupling between the gate and the drain of the transfer transistor M1, and the voltage VOUT1 also decreases accordingly. The settling of the voltage VOUT1 according to the change in the gate voltage of the transfer transistor M1 takes a certain time.

At the subsequent time t9, the reference signal generation circuit 48A starts a slope operation in which the voltage of the reference signal VRAMP changes with time. The counter circuit 58A starts counting up simultaneously with the start of the slope operation and outputs a count signal COUNT indicating the count value to the column circuit 42 of each column via the count signal line 60.

The comparison circuit 521 of the column circuit 42 compares the level of the voltage VOUT1 with the level of the reference signal VRAMP. The level of the output signal of the comparison circuit 521 is inverted at a timing when the magnitude relationship between the level of the voltage VOUT1 and the level of the reference signal VRAMP changes, for example, at time t10 in FIG. 9.

The memory 621W of the column circuit 42 holds the count value indicated by the count signal COUNT output from the counter circuit 58A at the timing when the level of the output signal of the comparison circuit 521 is inverted as digital data of the pixel signal of the light signal level of the pixel 12. In this way, AD conversion is performed on the pixel signal of the light signal level of the pixel 12. The digital data held in the memory 621W is transferred to the memory 621R and then transferred to the output circuit 80A in accordance with a control signal from the horizontal scanning circuit 70A.

The digital data of the pixel signals thus acquired are subjected to correction processing by digital corrected double sampling (CDS) in the subsequent output circuit 80A. In the correction processing by the digital CDS, the digital data of the pixel signal of the reset level is subtracted from the digital data of the pixel signal of the light signal level, and the noise component superimposed on the pixel signal of the light signal level is removed.

Although the readout operation from the pixel 12 connected to the signal line 161 is described here, the readout operation from the pixel 12 connected to the signal line 162 may be performed at the same timing as the readout operation from the pixel 12 connected to the signal line 161. In this case, similarly to the voltage VOUT1 of the signal line 161, in the signal line 162, it takes a certain time to settle the voltage VOUT2 due to the influence of capacitive coupling between the gates of the transfer transistor M1 and the reset transistor M2 and the node FD.

At this time, since it is difficult to make the parasitic capacitance associated with the signal line 161 and the parasitic capacitance associated with the signal line 162 the same, the time required for settling may differ between the signal lines 161 and 162. In FIG. 9, the voltage of the signal line 161 when the parasitic capacitance associated with the signal line 161 is larger than the parasitic capacitance associated with the signal line 162 and the column circuit 42 does not have the negative capacitance circuit 46 is indicated as a voltage VOUT1′.

In the case where the column circuit 42 does not have the negative capacitance circuit 46, as illustrated in FIG. 9, for example, after the time t1, the time required for the voltage VOUT1′ of the signal line 161 to settle is longer than the time required for the voltage VOUT2 to settle. When the time required for the potential settling is different between the signal line 161 and the signal line 162 as described above, there is a possibility that a characteristic difference occurs between the pixel 12 from which a signal is read out to the signal line 161 and the pixel 12 from which a signal is read out to the signal line 162, which may cause deterioration in image quality.

Here, a factor in which the parasitic capacitance associated with the signal line 161 and the parasitic capacitance associated with the signal line 162 are different from each other will be described with reference to FIG. 10A to FIG. 11F. FIG. 10A and FIG. 10B schematically illustrate the basic positional relationship of the signal lines 161 and 162 and the interconnections 181 and 182 adjacent thereto. FIG. 10A illustrates a planar positional relationship of the signal lines 161 and 162 and the interconnections 181 and 182, and FIG. 10B illustrates a cross-sectional view taken along line A-A′ of FIG. 10A. FIG. 11A to FIG. 11F illustrate modification examples of the arrangement of the signal lines 161 and 162 and the interconnections 181 and 182.

In FIG. 10A and FIG. 10B, the interconnections 181 and 182 are interconnections other than the signal lines constituting the output line groups 16A and 16B, and here, it is assumed that the interconnection 181 is a power supply voltage line and the interconnection 182 is a ground voltage line. The power supply voltage and the ground voltage supplied to the pixels 12 may be supplied via a power supply voltage line and a ground voltage line arranged in parallel to the output line groups 16A and 16B. In this case, a parasitic capacitance of a non-negligible amount may be formed between the voltage lines and the signal lines 161 and 162.

In FIG. 10A and FIG. 10B, it is assumed that the signal lines 161 and 162 and the interconnections 181 and 182 having the same line width and line thickness are arranged at equal intervals. In this case, there is no large difference between the parasitic capacitance associated with the signal line 161 and the parasitic capacitance associated with the signal line 162. However, the parasitic capacitance associated with the signal line 161 and the parasitic capacitance associated with the signal line 162 may differ depending on various factors. FIG. 11A to FIG. 11F illustrate some factors that cause a difference between the parasitic capacitance associated with the signal line 161 and the parasitic capacitance associated with the signal line 162.

FIG. 11A illustrates a case where the line width of the interconnection 181 is larger than the line width of the interconnection 182. In the pixel circuit of FIG. 2, a current always flows to the power supply voltage node during operation, but a steady current does not flow to the ground voltage node. Therefore, the power supply voltage interconnection (interconnection 181) may be wider than the ground voltage interconnection (interconnection 182) in order to relatively reduce the parasitic resistance. At this time, since the electrical flux lines from the signal lines 161 and 162 also extend to the upper and lower surfaces of the interconnections 181 and 182, the parasitic capacitance associated with the signal line 161 becomes larger than the parasitic capacitance associated with the signal line 162.

FIG. 11B illustrates the case where the interconnection interval between the signal line 161 and the interconnection 181 is wider than the interconnection interval between the signal line 162 and the interconnection 182. In order to suppress coupling of low-frequency noise of the power supply to the signal line 161, the interval between the power supply voltage line (the interconnection 181) and the signal line 161 may be larger than the interval between the ground voltage line (the interconnection 182) and the signal line 162. Such an arrangement may also cause a difference between the parasitic capacitance associated with the signal line 161 and the parasitic capacitance associated with the signal line 162.

FIG. 11C illustrates a case where the signal lines 161 and 162 and the interconnection 182 are formed of one interconnection layer, and the interconnection 181 is formed of an interconnection structure in which two interconnection layers are connected by contact vias. From the viewpoint of reducing the parasitic resistance, the power supply voltage line (the interconnection 181) may be formed of a plurality of interconnection layers, however, such a configuration may cause a parasitic capacitance associated with the signal line 161 to be different from a parasitic capacitance associated with the signal line 162. Since the parasitic capacitance associated with the signal line 161 and the parasitic capacitance associated with the signal line 162 are different from each other only when the number of contact vias connected to the interconnection 181 and the number of contact vias connected to the interconnection 182 are different from each other, it is very difficult to make the parasitic capacitances the same when the number of interconnection layers is changed.

FIG. 11D illustrates a case where an interconnection 183 different from the interconnections 181 and 182 is arranged above the signal line 161. Such a configuration may also cause a difference in parasitic capacitance between the signal line 161 and the signal line 162. In other words, the parasitic capacitance associated with the signal line 161 and the parasitic capacitance associated with the signal line 162 cannot be the same unless the signal line 161 and the signal line 162 have the same coverage with the interconnection arranged in the upper layer. The same applies to the interconnections arranged below the signal lines 161 and 162.

In addition, in the case where the line width of the signal line 161 is different from the line width of the signal line 162 as illustrated in FIG. 11E, or in the case where the line thickness of the signal line 161 is different from the line thickness of the signal line 162 as illustrated in FIG. 11F, the parasitic capacitance associated with the signal line 161 may be different from the parasitic capacitance associated with the signal line 162.

As described above, the relationship between the parasitic capacitance associated with the signal line 161 and the parasitic capacitance associated with the signal line 162 may vary depending on various factors. Therefore, it is difficult to avoid all of these factors and set the parasitic capacitance associated with the signal line 161 and the parasitic capacitance associated with the signal line 162 to be the same, and the parasitic capacitance associated with the signal line 161 and the parasitic capacitance associated with the signal line 162 are basically different from each other.

From such a viewpoint, in the photoelectric conversion device according to the present embodiment, the negative capacitance circuit 46 is connected to the signal line 161 having a relatively large parasitic capacitance among the signal lines 161 and 162 constituting the output line group 16 as a speed-up circuit for promoting a transient change in potential.

When the gain of the amplifier Amp is represented as A and the capacitance value of the capacitor C1 is represented as C, the negative capacitance circuit 46 contributes as a negative capacitance of −A×C under a certain condition. Therefore, by connecting the negative capacitance circuit 46 to the signal line 161, the capacitance associated with the signal line 161 is effectively reduced, and the settling time may be shortened. For example, when the parasitic capacitance associated with the signal line 162 is represented as CVL, the parasitic capacitance associated with the signal line 161 is CVL+ΔC, and the gain A of the amplifier Amp is 1, the parasitic capacitance difference between the signal lines 161 and 162 may be canceled by setting the capacitance value of the capacitor C1 to ΔC. If at least the capacitance value of the capacitor C1 is set in the range of more than 0 and less than 2 ΔC, the parasitic capacitance difference between the signal lines 161 and 162 may be made smaller than ΔC, and the effect of reducing the parasitic capacitance difference may be achieved. Although the optimum value of the capacitor C1 is ΔC, it can be said that a range obtained by adding the manufacturing variation of the capacitor to ΔC is the optimum range of the capacitor C1 in consideration of the manufacturing variation of the capacitor. For example, when the manufacturing variation of the capacitor is ±20%, it is desirable to set the capacitor C1 in the range of ΔC±20%.

By configuring the photoelectric conversion device in this manner, it is possible to reduce the time required to settle the potential of the signal line 161 and reduce the difference in the time required to settle the potential between the signal line 161 and the signal line 162. As a result, the voltage VOUT1 of the signal line 161 and the voltage VOUT2 of the signal line 162 have substantially the same waveform as illustrated in FIG. 9, for example, so that the characteristic difference due to the signal lines 161 and 162 from which signals are read out may be reduced, and image quality degradation may be suppressed.

As described above, according to the present embodiment, in a photoelectric conversion device including a plurality of signal lines arranged corresponding to pixels in one column, it is possible to reduce the influence of parasitic capacitance associated with the signal lines and suppress image quality degradation.

### Second Embodiment

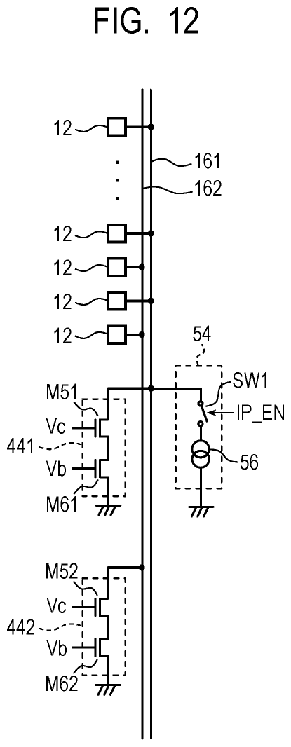

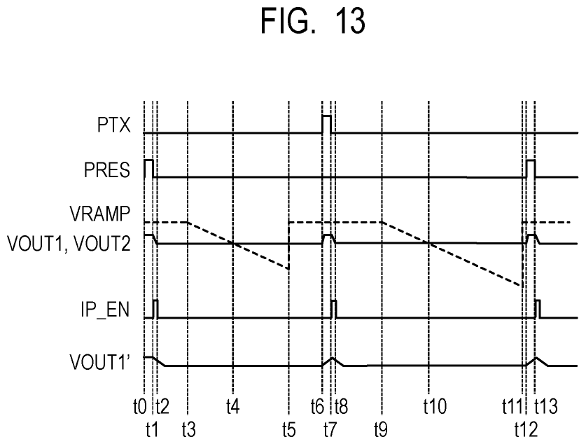

A photoelectric conversion device and a method of driving the same according to a second embodiment will be described with reference to FIG. 12 and FIG. 13. The same components as those of the photoelectric conversion device according to the first embodiment are denoted by the same reference numerals, and description thereof will be omitted or simplified. FIG. 12 is a circuit diagram illustrating a configuration example of the photoelectric conversion device according to the present embodiment. FIG. 13 is a timing chart illustrating a method of driving the photoelectric conversion device according to the present embodiment.

The photoelectric conversion device according to the present embodiment is different from the photoelectric conversion device according to the first embodiment in that the column circuit 42 includes a pulse current source circuit 54 instead of the negative capacitance circuit 46. Other points of the photoelectric conversion device according to the present embodiment are the same as those of the photoelectric conversion device according to the first embodiment.

As illustrated in, e.g., FIG. 12, the column circuit 42 of the photoelectric conversion device according to the present embodiment includes a pulse current source circuit 54 connected to the signal line 161. The pulse current source circuit 54 may include a current source 56 and a switch SW1. One terminal of the switch SW1 is connected to the signal line 161. The other terminal of the switch SW1 is connected to one terminal of the current source 56. The other terminal of the current source 56 is connected to the ground voltage line (fixed voltage node). The switch SW1 is controlled by a control signal IP_EN. For example, the switch SW1 is turned on (conductive state) when the control signal IP_EN is at high-level and is turned off (nonconductive state) when the control signal IP_EN is at low-level. Like the negative capacitance circuit 46 in the first embodiment, the pulse current source circuit 54 has a function as a speed-up circuit that promotes a transient change in the potential of the signal line 161.

Next, the operation of the photoelectric conversion device according to the present embodiment will be described with reference to FIG. 13. The timing chart of FIG. 13 illustrates waveforms of the control signals PTX and PRES, the reference signal VRAMP, the voltage VOUT1 of the signal line 161, and the voltage VOUT2 of the signal line 162.

In the present embodiment, the control signal IP_EN is controlled to high-level at a timing when the potentials of the signal lines 161 and 162 decrease due to coupling with the control line 14, and the switch SW1 is turned on. Specifically, the control signal IP_EN is controlled to high-level in a period from the time t1 to time t2 when the control signal PRES transitions from high-level to low-level. In addition, the control signal IP_EN is controlled to high-level in a period from the time t7 to time t8 when the control signal PTX transitions from high-level to low-level.

When the switch SW1 is turned on, the current source circuit 441 and the current source 56 are temporarily connected in parallel to the signal line 161, and the current flowing through the signal line 161 increases. Thus, the settling time of the voltage VOUT1 of the signal line 161 may be reduced. Therefore, even in the case where the parasitic capacitance associated with the signal line 161 is larger than the parasitic capacitance associated with the signal line 162, it is possible to reduce the difference in the settling time of the potential between the signal line 161 and the signal line 162. As a result, the characteristic difference due to the signal lines 161 and 162 from which signals are read out may be reduced, and image quality degradation may be suppressed.

As described above, according to the present embodiment, in a photoelectric conversion device including a plurality of signal lines arranged corresponding to pixels in one column, it is possible to reduce the influence of parasitic capacitance associated with the signal lines and suppress image quality degradation.

### Third Embodiment

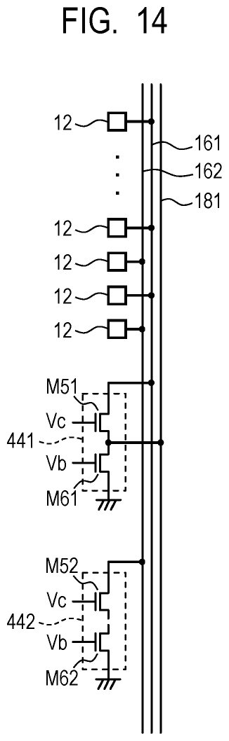

A photoelectric conversion device according to a third embodiment will be described with reference to FIG. 14. The same components as those of the photoelectric conversion device according to the first or second embodiment are denoted by the same reference numerals, and description thereof will be omitted or simplified. FIG. 14 is a circuit diagram illustrating a configuration example of the photoelectric conversion device according to the present embodiment.

As illustrated in FIG. 14, the photoelectric conversion device according to the present embodiment further includes an interconnection 181 arranged adjacent to the signal line 161 and electrically connected to a connection node between the transistor M51 and the transistor M61 of the current source circuit 441. In the present embodiment, the interconnection 181 functions as a speed-up circuit that promotes a transient change in the potential of the signal line 161, similarly to the negative capacitance circuit 46 in the first embodiment and the pulse current source circuit 54 in the second embodiment. In the photoelectric conversion device according to the present embodiment, the negative capacitance circuit 46 or the pulse current source circuit 54 is not necessarily required, but the negative capacitance circuit 46 or the pulse current source circuit 54 may be further provided together with the interconnection 181.

By arranging the interconnection 181 adjacent to the signal line 161, parasitic capacitance is formed between the signal line 161 and the interconnection 181. When the potential of the signal line 161 is lowered, a current flows from the drain of the transistor M61 to the parasitic capacitance between the signal line 161 and the interconnection 181 through the interconnection 181. By increasing the current flowing through the transistor M51 by the above amount of the current, it is possible to speed up the decrease in the potential of the signal line 161. Therefore, even in the case where the parasitic capacitance associated with the signal line 161 is larger than the parasitic capacitance associated with the signal line 162, it is possible to reduce the difference in the settling time of the potential between the signal line 161 and the signal line 162. As a result, the characteristic difference due to the signal lines 161 and 162 from which signals are read out may be reduced, and image quality degradation may be suppressed.

As described above, according to the present embodiment, in a photoelectric conversion device including a plurality of signal lines arranged corresponding to pixels in one column, it is possible to reduce the influence of parasitic capacitance associated with the signal lines and suppress image quality degradation.

### Fourth Embodiment

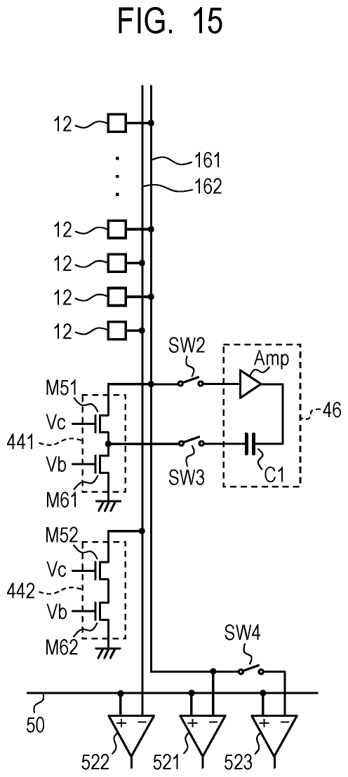

A photoelectric conversion device according to a fourth embodiment will be described with reference to FIG. 15. The same components as those of the photoelectric conversion devices according to the first to third embodiments are denoted by the same reference numerals, and description thereof will be omitted or simplified. FIG. 15 is a circuit diagram illustrating a configuration example of the photoelectric conversion device according to the present embodiment.

As illustrated in FIG. 15, the column circuit 42 of the photoelectric conversion device according to the present embodiment further includes switches SW2, SW3, and SW4, and a comparison circuit 523. Other configurations of the column circuit 42 of the present embodiment are the same as those of the column circuit 42 of the first embodiment.

The switch SW2 is connected between the signal line 161 and the input node of the negative capacitance circuit 46. The switch SW3 is connected between a connection node between the transistor M51 and the transistor M61 of the current source circuit 441 and the output node of the negative capacitance circuit 46. That is, the negative capacitance circuit 46 of the present embodiment is configured to be separable from the signal line 161 and the current source circuit 441. A comparison circuit 523 is further connected to the signal line 161 via a switch SW4. That is, the signal line 161 is connected to the comparison circuit 521 and may be connected to the comparison circuit 523.

By connecting the signal line 161 to the two comparison circuits 521 and 523 and averaging the AD conversion result output via the comparison circuit 521 and the AD conversion result output via the comparison circuit 523, random noise may be reduced. On the other hand, by connecting the comparison circuit 523 to the signal line 161, the input capacitance of the comparison circuit 523 is added to the signal line 161, which causes a decrease in the settling rate of the potential of the signal line 161. Therefore, in the low noise mode in which the signal line 161 is connected to the comparison circuits 521 and 523, the difference in the settling rate of the potential between the signal line 161 and the signal line 162 becomes large.

In the photoelectric conversion device according to the present embodiment, since connection and disconnection of the negative capacitance circuit 46 to the signal line 161 may be switched by the switches SW2 and SW3, connection and disconnection of the negative capacitance circuit 46 to the signal line 161 may be selected according to the operation mode. For example, in the low noise mode in which the comparison circuits 521 and 523 are connected to the signal line 161, the negative capacitance circuit 46 is connected to the signal line 161, so that it is possible to reduce the difference in the settling rate of the potential between the signal line 161 and the signal line 162. In the normal mode in which only the comparison circuit 521 is connected to the signal line 161, the negative capacitance circuit 46 may be disconnected from the signal line 161. This makes it possible to suppress image quality degradation in the specific mode.

As described above, according to the present embodiment, in a photoelectric conversion device including a plurality of signal lines arranged corresponding to pixels in one column, it is possible to reduce the influence of parasitic capacitance associated with the signal lines and suppress image quality degradation.

### Fifth Embodiment

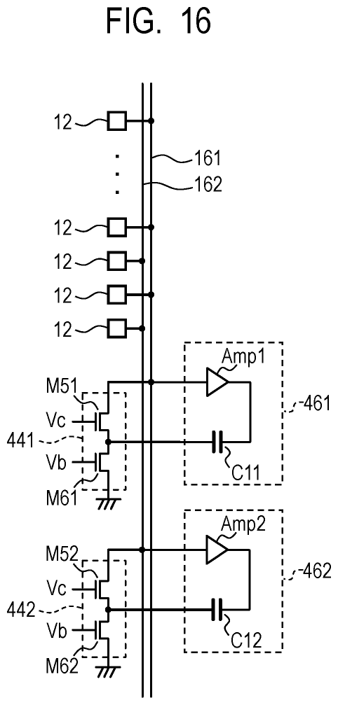

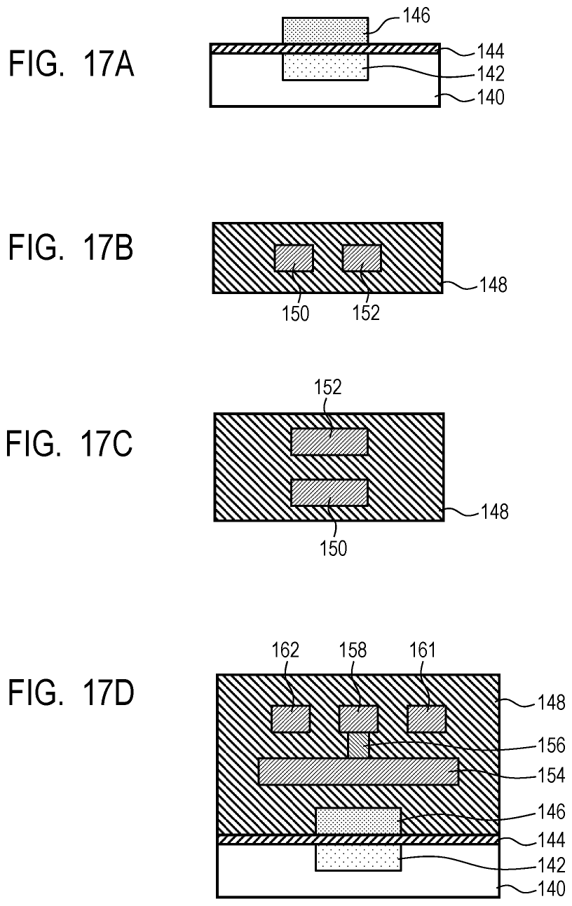

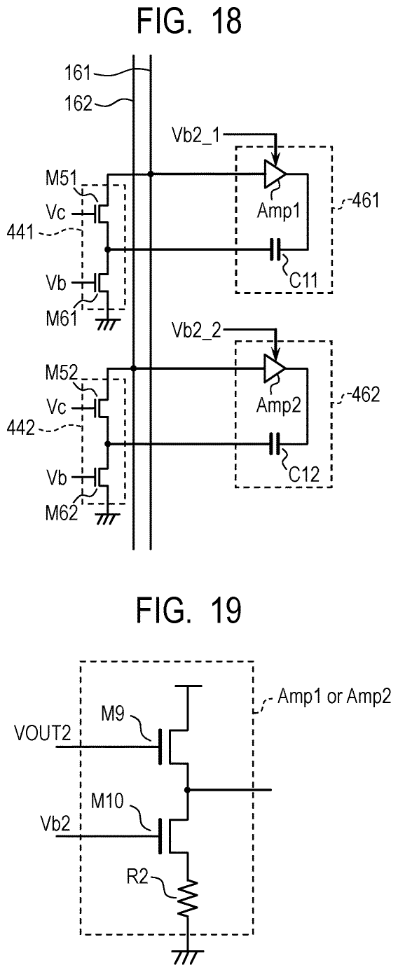

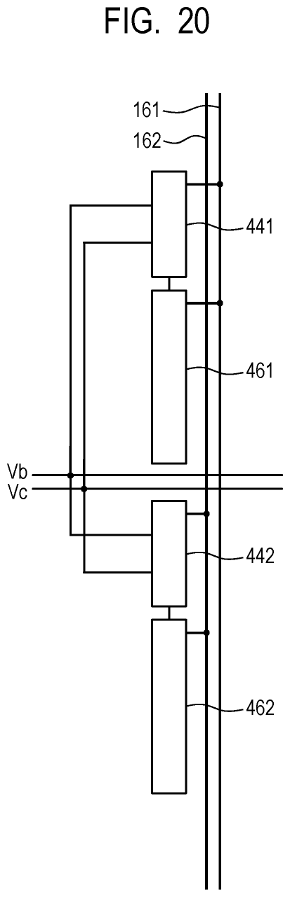

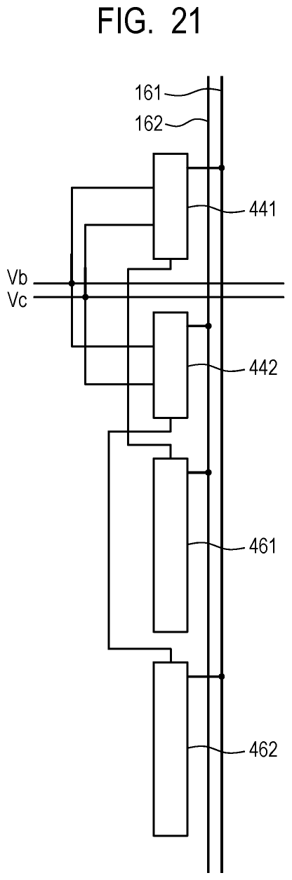

A photoelectric conversion device according to a fifth embodiment will be described with reference to FIG. 16 to FIG. 21. The same components as those of the photoelectric conversion devices according to the first to fourth embodiments are denoted by the same reference numerals, and description thereof will be omitted or simplified. FIG. 16 is a circuit diagram illustrating a configuration example of the photoelectric conversion device according to the present embodiment. FIG. 17A to FIG. 17D are cross-sectional views illustrating configuration examples of the capacitor in the photoelectric conversion device according to the present embodiment. FIG. 18 is a circuit diagram illustrating another configuration example of the photoelectric conversion device according to the present embodiment. FIG. 19 is a circuit diagram illustrating a configuration example of an amplifier of a negative capacitance circuit in the photoelectric conversion device according to the present embodiment. FIG. 20 and FIG. 21 are schematic diagrams illustrating layout examples of the current source circuit and the negative capacitance circuit in the photoelectric conversion device according to the present embodiment.

As illustrated in, e.g., FIG. 16, the column circuit 42 of the photoelectric conversion device according to the present embodiment further includes a negative capacitance circuit 462 connected to the signal line 162 and the current source circuit 442 in addition to the negative capacitance circuit 461 connected to the signal line 161 and the current source circuit 441. Other configurations of the column circuit 42 of the present embodiment are the same as those of the column circuit 42 of the first embodiment.

The negative capacitance circuit 461 may include an amplifier Amp1 and a capacitor C11. An input node of the amplifier Amp1 is connected to the signal line 161. An output node of the amplifier Amp1 is connected to one terminal of the capacitor C11. The other terminal of the capacitor C11 is connected to a connection node between the source of the transistor M51 and the drain of the transistor M61. Similarly, the negative capacitance circuit 462 may include an amplifier Amp2 and a capacitor C12. An input node of the amplifier Amp2 is connected to the signal line 162. An output node of the amplifier Amp2 is connected to one terminal of the capacitor C12. The other terminal of the capacitor C12 is connected to a connection node between the source of the transistor M52 and the drain of the transistor M62.

The negative capacitance circuit 461 and the negative capacitance circuit 462 have different characteristics (values of negative capacitance). Specifically, at least one of the capacitance values of the capacitors C11 and C12 and the gains of the amplifiers Amp1 and Amp2 are different. The characteristics of the negative capacitance circuits 461 and 462 are set according to the parasitic capacitances associated with the signal lines 161 and 162 to which they are connected. For example, when the capacitance value of the parasitic capacitance associated with the signal line 161 is CVL, the capacitance value of the parasitic capacitance associated with the signal line 162 is CVL+ΔC, and the gains of the amplifiers Amp1 and Amp2 are 1, the difference between the capacitance values of the capacitor C11 and the capacitor C12 may be set to ΔC. By setting the capacitance values of the capacitors C11 and C12 in this manner, it is possible to reduce the effective capacitance difference of the parasitic capacitances associated with the signal lines 161 and 162 and suppress the image quality degradation. Further, since the negative capacitance of the negative capacitance circuit 46 is represented by the product of the gain of the amplifier Amp and the capacitance value of the capacitor C1 as described above, the gains of the amplifiers Amp1 and Amp2 may be set so as to cancel out ΔC, instead of setting the capacitors C11 and C12 to different values. Alternatively, the capacitance values of the capacitors C11 and C12 and the gains of the amplifiers Amp1 and Amp2 may be set.

In addition to connecting the negative capacitance circuit 461 to the signal line 161, connecting the negative capacitance circuit 462 to the signal line 162 also has the effect of reducing the difference between the lower limits of the dynamic ranges of the signal lines 161 and 162 and further suppressing image quality degradation. In the first embodiment, as illustrated in FIG. 3, the amplifier Amp is connected only to the signal line 161. In order for the amplifier Amp to operate normally, in the circuit of, e.g., FIG. 7, it is necessary to apply a constant drain-source voltage Vds to the transistor M10 and apply a constant gate-source voltage Vgs to the transistor M9. When the voltage of the signal line 161 falls below Vds+Vgs, the amplifier Amp does not operate normally. As a result, the lower limit of the dynamic range of the signal line 161 is limited, and the dynamic range of the signal line 161 may be different from the dynamic range of the signal line 162. This results in a characteristic difference between the signals read out from the signal lines 161 and 162 at the time of high luminance, which may cause deterioration in image quality. In this regard, in the present embodiment, since the negative capacitance circuits 461 and 462 (amplifiers Amp1 and Amp2) are connected to the signal lines 161 and 162, respectively, the difference between the lower limits of the dynamic ranges of the signal lines 161 and 162 may be reduced.

Various structures illustrated in, e.g., FIG. 17A to FIG. 17D may be applied to the capacitors C11 and C12. FIG. 17A illustrates a metal-insulator-semiconductor (MIS) capacitor in which a semiconductor region 142 provided in a semiconductor substrate 140 and a gate electrode 146 provided over the semiconductor substrate 140 with an insulating film 144 therebetween serve as a pair of electrodes. The capacitance value may be changed depending on an area of a portion where the gate electrode 146 and the semiconductor region 142 face each other or a thickness of the insulating film 144. FIG. 17B and FIG. 17C illustrate inter-wiring capacitances in which the interconnections 150 and 152 arranged in the interlayer insulating film 148 serve as a pair of electrodes. The interconnections 150 and 152 may be formed of interconnection layers of the same level as illustrated in FIG. 17B or may be formed of interconnection layers of different levels as illustrated in FIG. 17C. The capacitance value may be changed depending on a distance between the interconnections 150 and 152, a line thickness of the interconnections 150 and 152, a line width of the interconnections 150 and 152, or the like.

The structures of the capacitors constituting the capacitors C11 and C12 are not necessarily the same and may be arbitrarily selected from, for example, FIG. 17A to FIG. 17C. Alternatively, at least one of the capacitors C11 and C12 may be configured using two or more capacitors selected from FIG. 17A to FIG. 17C. For example, when one of the capacitors C11 and C12 has the structure of FIG. 17A and the other has the structure of FIG. 17B or FIG. 17C, they may be arranged in the same region in a plan view, and the chip area may be reduced. Alternatively, by adopting the structure of FIG. 17A for both of the capacitors C11 and C12, crosstalk may be suppressed.

When the capacitors C11 and C12 are formed using the capacitor having the structure of FIG. 17A, it is also possible to shield the capacitors C11 and C12 from the signal lines 161 and 162 using metal interconnection. For example, as illustrated in FIG. 17D, a metal interconnection 154 may be arranged between the capacitor of the structure of FIG. 17A and the signal lines 161 and 162, and a metal interconnection 158 and a via 156 connecting the metal interconnection 154 and the metal interconnection 158 may be arranged between the signal line 161 and the signal line 162. By configuring the metal interconnections in this manner, it is possible to shield the space between the capacitor C11 and the signal line 162 and the space between the capacitor C12 and the signal line 162 by the metal interconnection 154, and it is possible to suppress crosstalk. Further, the metal interconnection 158 and the via 156 may shield the space between the signal line 161 and the signal line 162.

The amplifiers Amp1 and Amp2 may be configured to have different gains. The gains of the amplifiers Amp1 and Amp2 may be set to different values by, for example, making the size, threshold voltage, thickness of the gate insulating film, or the like of the transistor M9 different from each other. Further, by changing the size, threshold voltage, thickness of the gate insulating film, or the like of the transistor M10, the value of the current flowing through the transistor M10 may be set to different values. Alternatively, as illustrated in, e.g., FIG. 18, the bias voltage Vb2_1 supplied to the current source transistor of the amplifier Amp1 and the bias voltage Vb2_2 supplied to the current source transistor of the amplifier Amp2 may be set to different values. Alternatively, as illustrated in, e.g., FIG. 19, the source resistor R2 may be inserted between the source of the transistor M10 of one of the amplifier Amp1 and the amplifier Amp2 and the ground voltage line. However, when the configurations of the amplifiers Amp1 and Amp2 are different from each other, the dynamic ranges of the signal lines 161 and 162 may be different from each other as described above. Thus, it is preferable to change the capacitance values of the capacitors C11 and C12 rather than changing the configurations of the amplifiers Amp1 and Amp2.

FIG. 20 and FIG. 21 illustrate layout examples of the current source circuits 441 and 442 and the negative capacitance circuits 461 and 462 on the substrate on which the column circuit 42 is provided. FIG. 20 is a layout example in the case where the current source circuit 441 and the corresponding negative capacitance circuit 461 are arranged close to each other, and the current source circuit 442 and the corresponding negative capacitance circuit 462 are arranged close to each other. FIG. 21 is a layout example when the current source circuit 441 and the current source circuit 442 are arranged close to each other and the negative capacitance circuit 461 and the negative capacitance circuit 462 are arranged close to each other.

In the layout example of FIG. 20, the connection length between the paired current source circuit 44 and negative capacitance circuit 46 may be reduced. On the other hand, in the layout example of FIG. 21, the connection length between the current source circuit 44 and the negative capacitance circuit 46 forming a pair becomes longer. On the other hand, in the layout example of FIG. 21, the interconnection lengths of the interconnections for supplying the bias voltages Vb and Vc to the current source circuits 441 and 442 may be shortened, and the parasitic capacitance of the interconnection may be reduced. On the other hand, in the layout example of FIG. 20, the interconnection lengths of the interconnections for supplying the bias voltages Vb and Vc to the current source circuits 441 and 442 are longer, and the parasitic capacitance of the interconnection increases. Since each layout has advantages and disadvantages, it is desirable to select a layout to be applied in accordance with characteristics to be considered more important.

As described above, according to the present embodiment, in a photoelectric conversion device including a plurality of signal lines arranged corresponding to pixels in one column, it is possible to reduce the influence of parasitic capacitance associated with the signal lines and suppress image quality degradation.

### Sixth Embodiment

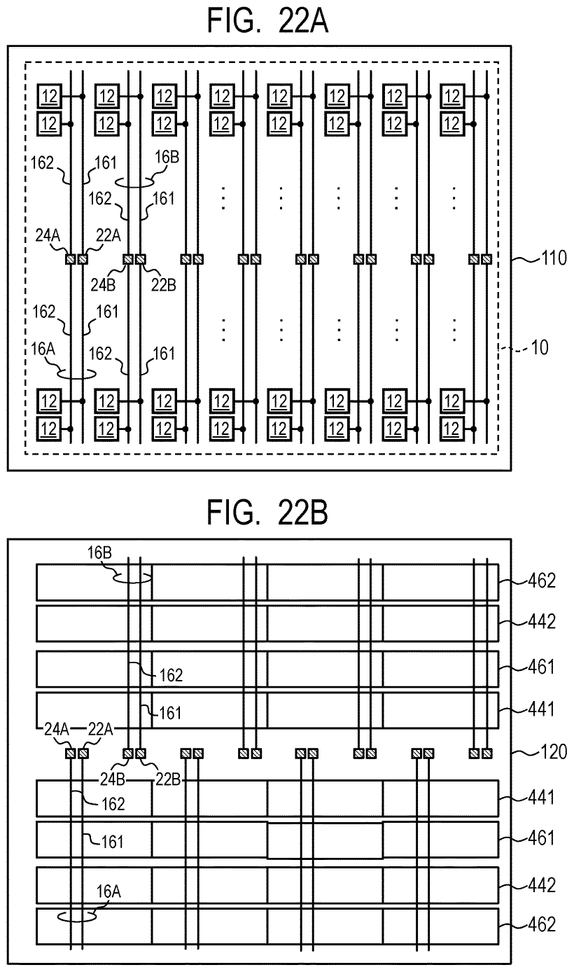

A photoelectric conversion device according to a sixth embodiment will be described with reference to FIG. 22A and FIG. 22B. The same components as those of the photoelectric conversion devices according to the first to fifth embodiments are denoted by the same reference numerals, and description thereof will be omitted or simplified. FIG. 22A and FIG. 22B are schematic diagrams illustrating a configuration example of the photoelectric conversion device according to the present embodiment.

In the present embodiment, a connection example between the pixel array unit 10, and the current source circuits 441 and 442 and the negative capacitance circuits 461 and 462 in a case where the photoelectric conversion device is configured by a plurality of substrates will be described. In the present embodiment, differences from the photoelectric conversion device according to the fifth embodiment will be mainly described, and description of portions similar to those of the photoelectric conversion device according to the fifth embodiment will be appropriately omitted.

The photoelectric conversion device according to the present embodiment is a stacked-type photoelectric conversion device including a pixel substrate 110 on which the pixel array unit 10 is arranged and a circuit substrate 120 on which other circuit blocks are arranged. FIG. 22A is a plan view of the pixel substrate 110, and FIG. 22B is a plan view of the circuit substrate 120. The photoelectric conversion device according to the present embodiment is configured by stacking these substrates so as to overlap each other in a planar manner. FIG. 22A and FIG. 22B illustrate eight columns of the plurality of columns constituting the pixel array unit 10, the plurality of pixels 12, the current source circuits 441 and 442, and the negative capacitance circuits 461 and 462 corresponding to each column. FIG. 22A and FIG. 22B illustrate the output line group 16A arranged in the odd-numbered columns, the output line group 16B arranged in the even-numbered columns, and electrical connecting portions 22A, 24A, 22B, and 24B between the pixel substrate 110 and the circuit substrate 120. In order to simplify the drawings, description of other constituent elements is omitted.

As illustrated in FIG. 22A and FIG. 22B, the pixel array unit 10 is arranged on the pixel substrate 110, and the current source circuits 441 and 442 and the negative capacitance circuits 461 and 462 are arranged on the circuit substrate 120. The output line group 16A is divided into a portion arranged on the pixel substrate 110 and a portion arranged on the circuit substrate 120, and these portions are connected to each other via connecting portions 22A and 24A. Similarly, the output line group 16B is divided into a portion arranged on the pixel substrate 110 and a portion arranged on the circuit substrate 120, and these portions are connected to each other via the connecting portions 22B and 24B. The connecting portions 22A and 22B are connecting portions of the signal line 161, and the connecting portions 24A and 24B are connecting portions of the signal line 162. The connecting portions 22A, 24A, 22B, and 24B are arranged in the vicinity of the central row among the plurality of rows configuring the pixel array unit 10.

Accordingly, the pixels 12 in the odd-numbered columns are connected to the current source circuits 441 and 442 and the negative capacitance circuits 461 and 462 of the readout circuit 40A via the output line group 16A arranged on the pixel substrate 110, the connecting portions 22A and 24A, and the output line group 16A arranged on the circuit substrate 120. Similarly, the pixels 12 in the even-numbered columns are connected to the current source circuits 441 and 442 and the negative capacitance circuits 461 and 462 of the readout circuit 40B via the output line group 16B arranged on the pixel substrate 110, the connecting portions 22B and 24B, and the output line group 16B arranged on the circuit substrate 120.

As described above, in the present embodiment, in the stacked-type photoelectric conversion device, the output line groups 16A and 16B are connected to the current source circuits 441 and 442 and the negative capacitance circuits 461 and 462 via the connecting portions 22A, 22B, 24A, and 24B arranged in the vicinity of the central pixel row. Accordingly, the distances from the current source circuits 441 and 442 to the upper and lower ends of the output line groups 16A and 16B arranged on the pixel substrate 110 may be reduced, and parasitic resistance and parasitic capacitance associated with the output line groups 16A and 16B arranged on the pixel substrate 110 may be reduced.

As described above, according to the present embodiment, in a photoelectric conversion device including a plurality of signal lines arranged corresponding to pixels in one column, it is possible to reduce the influence of parasitic capacitance associated with the signal lines and suppress image quality degradation.

### Seventh Embodiment

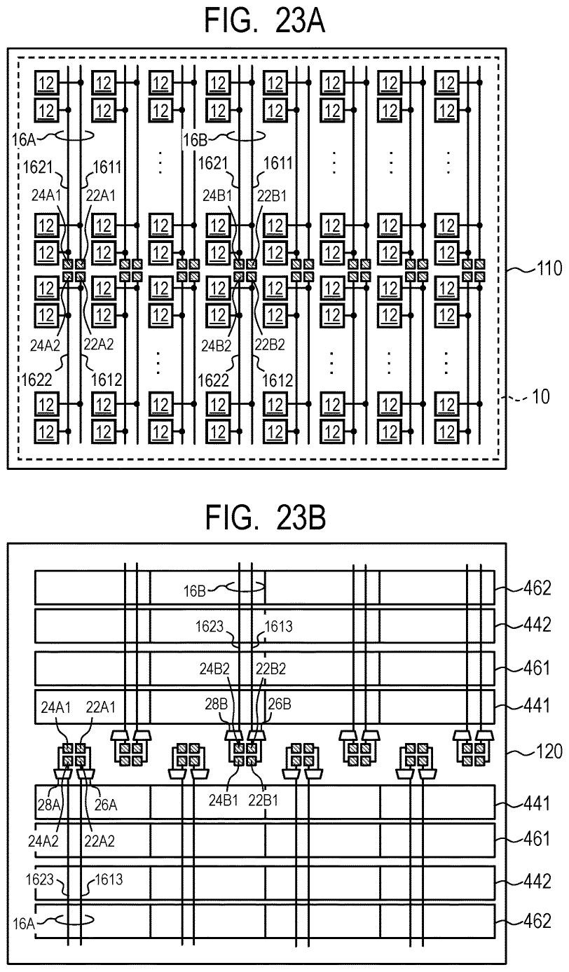

A photoelectric conversion device according to a seventh embodiment will be described with reference to FIG. 23A and FIG. 23B. The same components as those of the photoelectric conversion devices according to the first to sixth embodiments are denoted by the same reference numerals, and description thereof will be omitted or simplified. FIG. 23A and FIG. 23B are schematic diagrams illustrating a configuration example of the photoelectric conversion device according to the present embodiment.

In the present embodiment, as in the sixth embodiment, an example of connection between the pixel array unit 10, and the current source circuits 441 and 442 and the negative capacitance circuits 461 and 462 in a case where the photoelectric conversion device is formed of a plurality of substrates will be described. In the present embodiment, differences from the photoelectric conversion device of the sixth embodiment will be mainly described, and description of portions similar to those of the photoelectric conversion device of the fifth embodiment will be appropriately omitted.

In the present embodiment, the signal lines 161 and 162 constituting the output line group 16A arranged on the pixel substrate 110 are divided into signal lines 1611 and 1612 and signal lines 1621 and 1622 in the vicinity of the central row among the plurality of rows. The connecting portion 22A is divided into connecting portions 22A1 and 22A2 corresponding to the signal lines 1611 and 1612, and the connecting portion 24A is divided into connecting portions 24A1 and 24A2 corresponding to the signal lines 1621 and 1622. The connecting portions 22A and 22A2 are connected to a selection circuit (multiplexer) 26A provided on the circuit substrate 120 and are configured to select one of the signal line 1611 and the signal line 1612 and connect the selected signal line to a signal line 1613 provided on the circuit substrate 120. The connecting portions 24A1 and 24A2 are connected to the selection circuit 28A provided on the circuit substrate 120 and are configured to select one of the signal line 1621 and the signal line 1622 and connect the selected signal line to the signal line 1623 provided on the circuit substrate 120.

Further, the signal lines 161 and 162 constituting the output line group 16B arranged on the pixel substrate 110 are divided into signal lines 1611 and 1612 and signal lines 1621 and 1622 in the vicinity of the central row among the plurality of rows. The connecting portion 22B is divided into connecting portions 22B1 and 22B2 corresponding to the signal lines 1611 and 1612, and the connecting portion 24B is divided into connecting portions 24B1 and 24B2 corresponding to the signal lines 1621 and 1622. The connecting portions 22B1 and 22B2 are connected to the selection circuit 26B provided on the circuit substrate 120 and are configured to select one of the signal line 1611 and the signal line 1612 and connect the selected signal line to the signal line 1613 provided on the circuit substrate 120. The connecting portions 24B1 and 24B2 are connected to the selection circuit 28B provided on the circuit substrate 120 and are configured to select one of the signal line 1621 and the signal line 1622 and connect the selected signal line to the signal line 1623 provided on the circuit substrate 120.

Accordingly, the pixels 12 in the odd-numbered columns are connected to the current source circuits 441 and 442 and the negative capacitance circuits 461 and 462 of the readout circuit 40A via the output line group 16A arranged on the pixel substrate 110, the connecting portions 22A and 24A, and the output line group 16A arranged on the circuit substrate 120. Similarly, the pixels 12 in the even-numbered columns are connected to the current source circuits 441 and 442 and the negative capacitance circuits 461 and 462 of the readout circuit 40B via the output line group 16B arranged on the pixel substrate 110, the connecting portions 22B and 24B, and the output line group 16B arranged on the circuit substrate 120.

In the readout operation, the signal line 1611 is selected by the selection circuits 26A and 26B, and the signal line 1621 is selected by the selection circuits 28A and 28B, respectively, and readout of the pixels 12 in the row corresponding to the signal lines 1611 and 1621 are sequentially performed. Thereafter, the signal line 1612 is selected by the selection circuits 26A and 26B, and the signal line 1622 is selected by the selection circuits 28A and 28B, respectively, and readout of the pixels 12 in the row corresponding to the signal lines 1612 and 1622 is sequentially performed.

At this time, when the parasitic capacitance difference between the signal lines 1611 and 1621 is set to AC and the capacitance difference between the negative capacitance circuits 461 and 462 is set to AC, it is desirable that the parasitic capacitance difference between the signal lines 1612 and 1622 is also set to AC. In view of the above, it is preferable that the signal lines 1611, 1612, 1621, and 1622 have substantially the same line width. It is preferable that a space between the signal lines 1611 and 1621 be substantially the same as a space between the signal lines 1612 and 1622. In addition, it is preferable that the signal lines 1611, 1612, 1621, and 1622 have substantially the same interconnection length. As a result, image quality degradation generated in a case where the difference in effective capacitance between the signal lines 1612 and 1622 cannot be reduced although the difference in effective capacitance between the signal lines 1611 and 1621 may be reduced may be prevented.

As described above, according to the present embodiment, in a photoelectric conversion device including a plurality of signal lines arranged corresponding to pixels in one column, it is possible to reduce the influence of parasitic capacitance associated with the signal lines and suppress image quality degradation.

### Eighth Embodiment

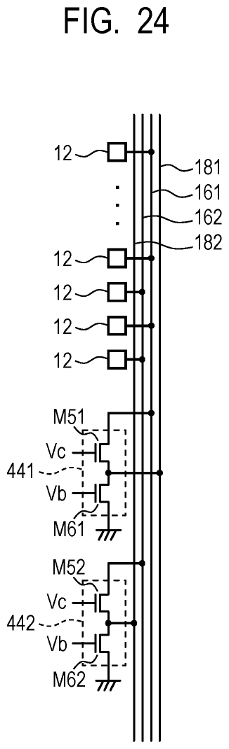

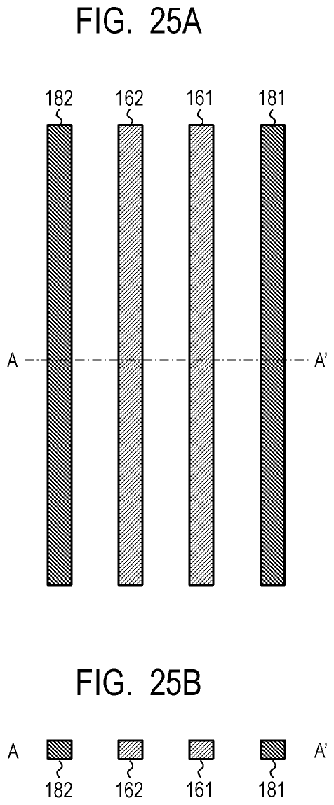

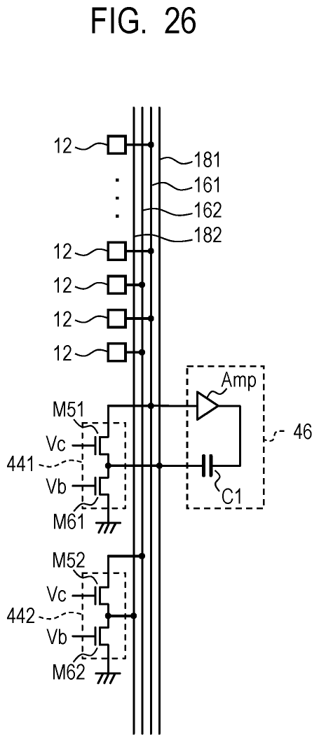

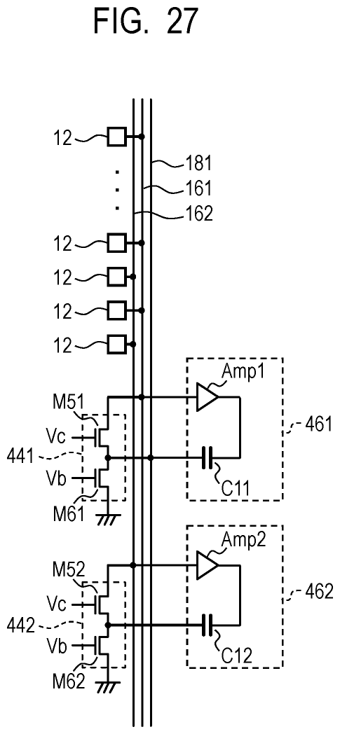

A photoelectric conversion device according to an eighth embodiment will be described with reference to FIG. 24 to FIG. 27. The same components as those of the photoelectric conversion devices according to the first to seventh embodiments are denoted by the same reference numerals, and description thereof will be omitted or simplified. FIG. 24 is a circuit diagram illustrating a configuration example of the photoelectric conversion device according to the present embodiment. FIG. 25A and FIG. 25B are diagrams illustrating arrangement examples of signal lines and interconnections in the photoelectric conversion device according to the present embodiment. FIG. 26 and FIG. 27 are circuit diagrams illustrating other configuration examples of the photoelectric conversion device according to the present embodiment.

As illustrated in FIG. 24, in the photoelectric conversion device according to the present embodiment, an interconnection 182 is further added to the photoelectric conversion device according to the third embodiment. The interconnection 182 is arranged adjacent to the signal line 162 and is electrically connected to a connection node between the transistor M52 and the transistor M62 of the current source circuit 442. In the present embodiment, the interconnection 182 functions as a high-speed circuit that promotes a transient change in the potential of the signal line 162, similarly to the interconnection 181 in the third embodiment. FIG. 25A and FIG. 25B schematically illustrate positional relationships between the signal lines 161 and 162 and the interconnections 181 and 182 adjacent thereto. FIG. 25A illustrates a planar positional relationship between the signal lines 161 and 162 and the interconnections 181 and 182, and FIG. 25B illustrates a cross-sectional view taken along line A-A′ of FIG. 25A.

In the fifth embodiment, the effective capacitance difference of the parasitic capacitance accompanied by the signal lines 161 and 162 is reduced by changing the characteristics of the negative capacitance circuits 461 and 462, but in the present embodiment, this can be realized by changing the configuration of the interconnections 181 and 182. For example, by changing the space between the signal line 161 and the interconnection 181 and the space between the signal line 162 and the interconnection 182, parasitic capacitances associated with the signal lines 161 and 162 may be made different. As a method of differentiating the parasitic capacitances associated with the signal lines 161 and 162, for example, various methods described with reference to FIG. 11A to FIG. 11F may be applied.

In addition, as illustrated in, e.g., FIG. 26, a negative capacitance circuit 46 connected to the signal line 161 and the interconnection 181 may be added to the photoelectric conversion device according to the present embodiment. In this case, the space between the signal line 161 and the interconnection 181 and the space between the signal line 162 and the interconnection 182 may be set to be the same, and the effect of speeding up the signal lines 161 and 162 may be made different by the negative capacitance circuit 46. With this configuration, it is possible to reduce the restrictions on the layout of the signal lines 161 and 162 and the interconnections 181 and 182, which is advantageous in reducing the size of the pixel 12.

Alternatively, as illustrated in, e.g., FIG. 27, a negative capacitance circuit 461 connected to the signal line 161 and the interconnection 181 and a negative capacitance circuit 462 connected to the signal line 162 and the interconnection 182 may be added and the interconnection 182 may be removed. In this case, the effect of speeding up the signal lines 161 and 162 may be made different by the interconnection 181 connected to the drain of the transistor M61. According to this configuration, since the amplifiers Amp1 and Amp2 of the negative capacitance circuits 461 and 462 are connected to both of the signal lines 161 and 162, it is possible to match the dynamic ranges of the signal lines 161 and 162.

As described above, according to the present embodiment, in a photoelectric conversion device including a plurality of signal lines arranged corresponding to pixels in one column, it is possible to reduce the influence of parasitic capacitance associated with the signal lines and suppress image quality degradation.

### Ninth Embodiment

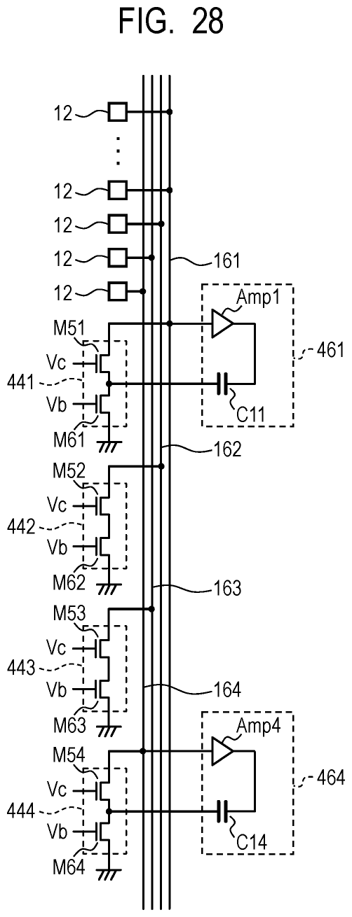

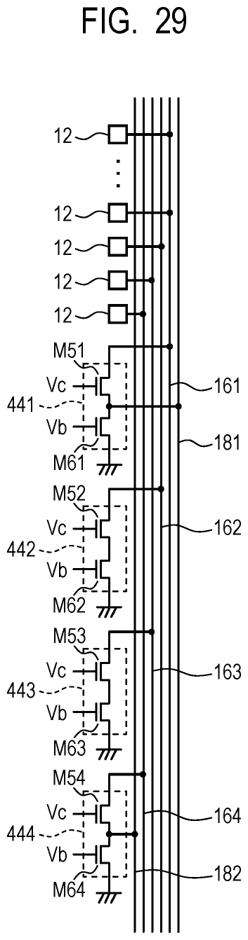

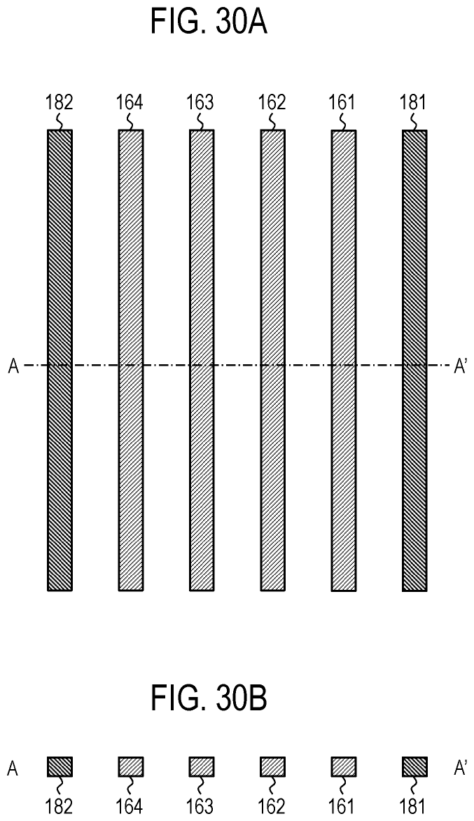

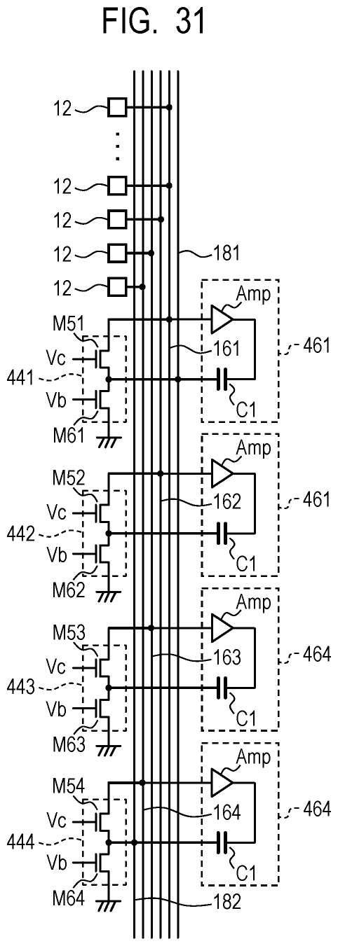

A photoelectric conversion device according to a ninth embodiment will be described with reference to FIG. 28 to FIG. 31. The same components as those of the photoelectric conversion devices according to the first to eighth embodiments are denoted by the same reference numerals, and description thereof will be omitted or simplified FIG. 28 is a circuit diagram illustrating a configuration example of the photoelectric conversion device according to the present embodiment. FIG. 29 and FIG. 31 are circuit diagrams illustrating other configuration examples of the photoelectric conversion device according to the present embodiment. FIG. 30A and FIG. 30B are diagrams illustrating arrangement examples of signal lines and interconnections in the photoelectric conversion device according to the present embodiment.

As illustrated in FIG. 28, the photoelectric conversion device according to the present embodiment includes four signal lines 161, 162, 163, and 164 constituting the output line group 16 in each column of the pixel array unit 10 and is configured to be capable of simultaneously reading out signals of pixels 12 of four rows. Current source circuits 441, 442, 443, and 444 are respectively connected to signal lines 161, 162, 163, and 164. Negative capacitance circuits 461 and 462 are connected to the signal line 161 and the signal line 164 located at both ends of the four signal lines 161, 162, 163, and 164, respectively.

Similarly to the current source circuits 441 and 442, the current source circuit 443 functions as a load current source of the amplifier transistor M3 of the pixel 12 and may include, for example, n-channel transistors M53 and M63. The transistor M53 functions as a cascode transistor, and the transistor M63 functions as a current source transistor. A drain of the transistor M53 is connected to the signal line 163. A source of the transistor M53 is connected to a drain of the transistor M63. A source of the transistor M63 is connected to the ground voltage line (fixed voltage node). The voltage Vc is supplied from the bias circuit 30A to a gate of the transistor M53. The voltage Vb is supplied from the bias circuit 30A to a gate of the transistor M63.

Similarly to the current source circuits 441 and 442, the current source circuit 444 functions as a load current source of the amplifier transistor M3 of the pixel 12 and may include, for example, n-channel transistors M54 and M64. The transistor M54 functions as a cascode transistor, and the transistor M64 functions as a current source transistor. A drain of the transistor M54 is connected to the signal line 164. A source of the transistor M54 is connected to a drain of the transistor M64. A source of the transistor M64 is connected to the ground voltage line (fixed voltage node). The voltage Vc is supplied from the bias circuit 30A to a gate of the transistor M54. The voltage Vb is supplied from the bias circuit 30A to a gate of the transistor M64.

Like the negative capacitance circuit 461, the negative capacitance circuit 464 may include an amplifier Amp4 and a capacitor C14. An input node of the amplifier Amp4 is connected to the signal line 164. An output node of the amplifier Amp4 is connected to one terminal of the capacitor C14. The other terminal of the capacitor C14 is connected to a connection node between the source of the transistor M54 and the drain of the transistor M64.

Among the four signal lines 161, 162, 163, and 164, the signal lines 161 and 163 are arranged on both sides of the signal line 162, and the signal lines 162 and 164 are arranged on both sides of the signal line 163. Therefore, the parasitic capacitances associated with the signal lines 162 and 163 are mainly caused by the capacitances with the other signal lines constituting the output line group 16. In addition, the signal lines 161, 162, 163, and 164 operates similarly as in the example of the waveforms of the voltages VOUT1 and VOUT2 in FIG. 9 in many cases, and parasitic capacitances between the signal lines 161, 162, 163, and 164 do not easily contribute as load capacitance. Therefore, the two signal lines 162 and 163 at the center may be expected to operate at a higher speed than the two signal lines 161 and 164 at both ends.

On the other hand, among the four signal lines 161, 162, 163, and 164, the signal lines 161 and 164 located at both ends have signal lines constituting the output line group 16 arranged only on one side, and there is a possibility that a parasitic capacitance is formed between these signal lines and the power supply voltage line or the ground voltage line (not illustrated). Therefore, the operation speed of the signal lines 161 and 164 tends to be lower than that of the signal lines 162 and 163. From such a viewpoint, in the photoelectric conversion device according to the present embodiment, the negative capacitance circuit 461 and the negative capacitance circuit 464 are respectively connected to the signal line 161 and the signal line 164 located at both ends among the four signal lines 161, 162, 163, and 164 to improve the operation speed.

Instead of connecting the negative capacitance circuits 461 and 464 to the signal lines 161 and 164 located at both ends, as illustrated in, e.g., FIG. 29, the interconnections 181 and 182 may be arranged so as to be adjacent to the signal lines 161 and 164. The interconnection 181 is arranged adjacent to the signal line 161 and is electrically connected to a connection node between the transistor M51 and the transistor M61 of the current source circuit 441. The interconnection 182 is arranged adjacent to the signal line 164 and is electrically connected to a connection node between the transistor M54 and the transistor M64 of the current source circuit 444. This configuration may also improve the operation speed of the signal lines 161 and 164 as described in the eighth embodiment.

FIG. 30A and FIG. 30B schematically illustrate the positional relationship between the signal line 161, 162, 163, and 164 and the interconnections 181 and 182 adjacent thereto. FIG. 30A illustrates a planar positional relationship between the signal line 161, 162, 163, and 164 and the interconnections 181 and 182, and FIG. 30B illustrates a cross-sectional view taken along line A-A′ of FIG. 30A. As illustrated in, e.g., FIG. 30A and FIG. 30B, the signal line 161, 162, 163, and 164 and the interconnections 181 and 182 may be formed by interconnection layers of the same level, and the line width, the line thickness, and the line interval may be uniformly set.

Alternatively, as illustrated in, e.g., FIG. 31, negative capacitance circuits 461, 462, 463, and 464 may be respectively connected to the signal lines 161, 162, 163, and 164. With such a structure, the influence of parasitic capacitances associated with each signal lines 161, 162, 163, and 164 may be reduced more effectively.

As described above, according to the present embodiment, in a photoelectric conversion device including a plurality of signal lines arranged corresponding to pixels in one column, it is possible to reduce the influence of parasitic capacitance associated with the signal lines and suppress image quality degradation.

### Tenth Embodiment

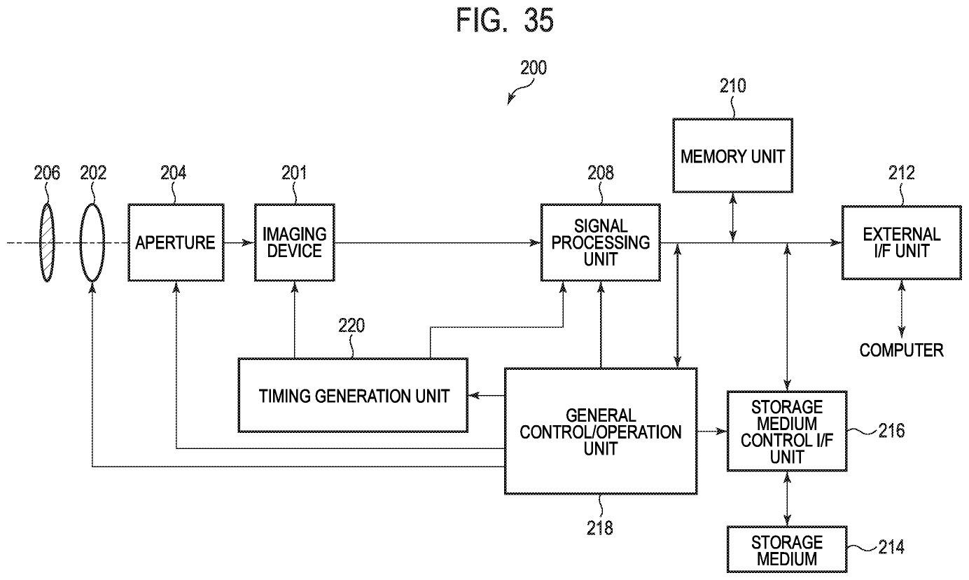

A photoelectric conversion system according to a tenth embodiment will be described with reference to FIG. 35. FIG. 35 is a block diagram illustrating a schematic configuration of a photoelectric conversion system according to the present embodiment.

The photoelectric conversion device 100 described in the first to ninth embodiments may be applied to various photoelectric conversion systems. Examples of applicable photoelectric conversion systems include digital still cameras, digital camcorders, surveillance cameras, copying machines, facsimiles, mobile phones, on-vehicle cameras, observation satellites, and the like. A camera module including an optical system such as a lens and an imaging device is also included in the photoelectric conversion system. FIG. 35 exemplifies a block diagram of a digital still camera as one of these.

The photoelectric conversion system 200 illustrated in FIG. 35 includes an imaging device 201, a lens 202 that forms an optical image of an object on the imaging device 201, an aperture 204 that changes the amount of light passing through the lens 202, and a barrier 206 that protects the lens 202. The lens 202 and the aperture 204 form an optical system that focuses light onto the imaging device 201. The imaging device 201 is the photoelectric conversion device 100 described in any of the first to ninth embodiments, and converts the optical image formed by the lens 202 into image data.

The photoelectric conversion system 200 further includes a signal processing unit 208 that processes an output signal output from the imaging device 201. The signal processing unit 208 generates image data from the digital signal output from the imaging device 201. Further, the signal processing unit 208 performs various corrections and compressions as necessary and outputs the processed image data. The imaging device 201 may include an AD conversion unit that generates a digital signal to be processed by the signal processing unit 208. The AD conversion unit may be formed on a semiconductor layer (semiconductor substrate) on which the photoelectric conversion unit of the imaging device 201 is formed or may be formed on a semiconductor layer different from the semiconductor layer on which the photoelectric conversion unit of the imaging device 201 is formed. The signal processing unit 208 may be formed on the same semiconductor layer as the imaging device 201.

The photoelectric conversion system 200 further includes a memory unit 210 for temporarily storing image data and an external interface unit (external I/F unit) 212 for communicating with an external computer or the like. The photoelectric conversion system 200 further includes a storage medium 214 such as a semiconductor memory for performing storing or reading out of imaging data, and a storage medium control interface unit (storage medium control I/F unit) 216 for performing storing on or reading out from the storage medium 214. The storage medium 214 may be built in the photoelectric conversion system 200 or may be detachable.

The photoelectric conversion system 200 further includes a general control/operation unit 218 that performs various calculations and controls the entire digital still camera, and a timing generation unit 220 that outputs various timing signals to the imaging device 201 and the signal processing unit 208. Here, the timing signal or the like may be input from the outside, and the photoelectric conversion system 200 may include at least the imaging device 201 and the signal processing unit 208 that processes the output signal output from the imaging device 201.

The imaging device 201 outputs an imaging signal to the signal processing unit 208. The signal processing unit 208 performs predetermined signal processing on the imaging signal output from the imaging device 201, and outputs the processed image data. The signal processing unit 208 generates an image using the imaging signal.

As described above, according to the present embodiment, it is possible to realize a photoelectric conversion system to which the photoelectric conversion device 100 according to any of the first to ninth embodiments is applied.

### Eleventh Embodiment

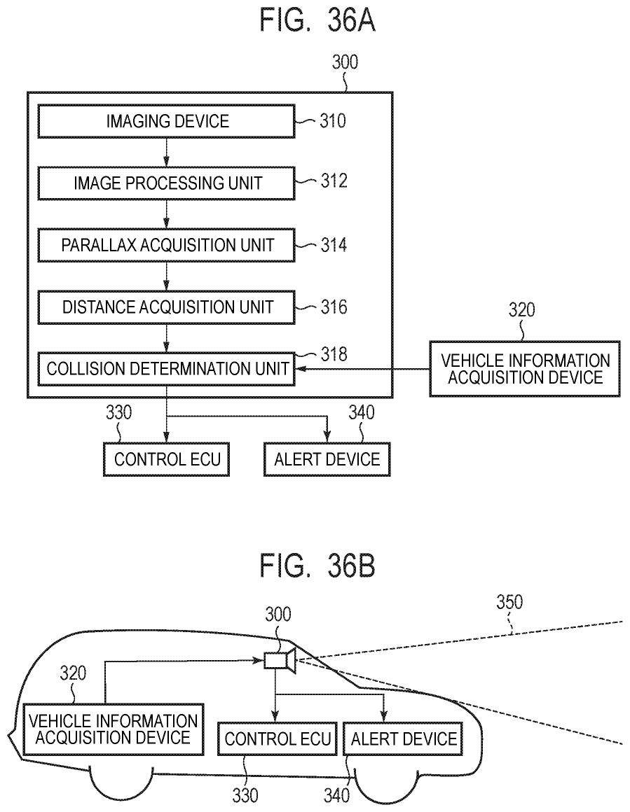

A photoelectric conversion system and a movable object according to an eleventh embodiment will be described with reference to FIG. 36A and FIG. 36B. FIG. 36A is a diagram illustrating a configuration of a photoelectric conversion system according to the present embodiment. FIG. 36B is a diagram illustrating a configuration of a movable object according to the present embodiment.

FIG. 36A illustrates an example of a photoelectric conversion system related to an on-vehicle camera. The photoelectric conversion system 300 includes an imaging device 310. The imaging device 310 is the photoelectric conversion device 100 according to any one of the first to ninth embodiments. The photoelectric conversion system 300 includes an image processing unit 312 that performs image processing on a plurality of image data acquired by the imaging device 310, and a parallax acquisition unit 314 that calculates parallax (phase difference of parallax images) from the plurality of image data acquired by the imaging device 310. The photoelectric conversion system 300 further includes a distance acquisition unit 316 that calculates a distance to an object based on the calculated parallax, and a collision determination unit 318 that determines whether there is a collision possibility based on the calculated distance. Here, the parallax acquisition unit 314 and the distance acquisition unit 316 are examples of a distance information acquisition unit that acquires distance information to the object. That is, the distance information is information related to a parallax, a defocus amount, a distance to the object, and the like. The collision determination unit 318 may determine the collision possibility using any of the distance information. The distance information acquisition unit may be realized by dedicatedly designed hardware or may be realized by a software module. Further, it may be realized by a field programmable gate array (FPGA), an application specific integrated circuit (ASIC), or the like, or may be realized by a combination of these.

The photoelectric conversion system 300 is connected to the vehicle information acquisition device 320, and may acquire vehicle information such as a vehicle speed, a yaw rate, and a steering angle. Further, the photoelectric conversion system 300 is connected to a control ECU 330 which is a control device that outputs a control signal for generating a braking force to the vehicle based on the determination result of the collision determination unit 318. The photoelectric conversion system 300 is also connected to an alert device 340 that issues an alert to the driver based on the determination result of the collision determination unit 318. For example, when the determination result of the collision determination unit 318 indicates that the possibility of collision is high, the control ECU 330 performs vehicle control to avoid collision and reduce damage by, for example, applying a brake, returning an accelerator, or suppressing engine output. The alert device 340 gives an alert to the user by sounding an alarm such as a sound, displaying alert information on a screen of a car navigation system or the like, giving vibration to a seat belt or a steering wheel, or the like.

In the present embodiment, an image of the surroundings of the vehicle, for example, the front or the rear is captured by the photoelectric conversion system 300. FIG. 36B illustrates the photoelectric conversion system in the case of capturing an image in front of the vehicle (imaging range 350). The vehicle information acquisition device 320 sends instructions to the photoelectric conversion system 300 or the imaging device 310. With such configuration, the accuracy of distance measurement may be further improved.

Although an example in which control is performed so as not to collide with another vehicle has been described above, the present invention is also applicable to control in which automatic driving is performed so as to follow another vehicle, control in which automatic driving is performed so as not to protrude from a lane, and the like. Further, the photoelectric conversion system is not limited to a vehicle such as an own vehicle, and may be applied to, for example, other movable objects (mobile devices), such as, for example, a ship, an aircraft, or an industrial robot. In addition, the present invention is not limited to the movable object and may be widely applied to equipment using object recognition, such as intelligent transport systems (ITS).

### Twelfth Embodiment

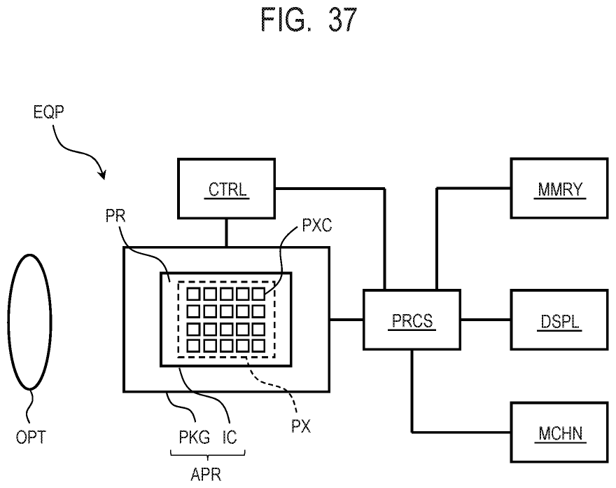

An equipment according to a twelfth embodiment will be described with reference to FIG. 37. FIG. 37 is a block diagram illustrating a schematic configuration of an equipment according to the present embodiment.

FIG. 37 is a schematic diagram illustrating an equipment EQP including a photoelectric conversion device APR. The photoelectric conversion device APR has the function of the photoelectric conversion device 100 according to any of the first to ninth embodiments. All or part of the photoelectric conversion device APR is a semiconductor device IC. The photoelectric conversion device APR of the present example may be used as, for example, an image sensor, an auto focus (AF) sensor, a photometric sensor, or a distance measurement sensor. The semiconductor device IC includes a pixel region PX in which pixel circuits PXC each including a photoelectric conversion unit are arranged in a matrix. The semiconductor device IC may include a peripheral region PR around the pixel region PX. A circuit other than the pixel circuit may be arranged in the peripheral region PR.

The photoelectric conversion device APR may have a structure (chip stacked structure) in which a first semiconductor chip provided with a plurality of photoelectric conversion units and a second semiconductor chip provided with a peripheral circuit are stacked. Each of the peripheral circuits in the second semiconductor chip may be a column circuit corresponding to a pixel column of the first semiconductor chip. The peripheral circuits in the second semiconductor chip may be matrix circuits corresponding to pixels or pixel blocks in the first semiconductor chip. As the connection between the first semiconductor chip and the second semiconductor chip, a through electrode (through silicon via (TSV)), an inter-chip interconnection by direct bonding of a conductor such as copper, a connection by a micro bump between chips, a connection by wire bonding, or the like may be employed.

The photoelectric conversion device APR may include a package PKG that accommodates the semiconductor device IC in addition to the semiconductor device IC. The package PKG may include a base body to which the semiconductor device IC is fixed, a lid body such as glass facing the semiconductor device IC, and connection members such as bonding wires or bumps for connecting terminals provided on the base body and terminal provided on the semiconductor device IC.

The equipment EQP may further include at least one of an optical device OPT, a control device CTRL, a processing device PRCS, a display device DSPL, a storage device MMRY, and a mechanical device MCHN. The optical device OPT corresponds to the photoelectric conversion device APR as a photoelectric conversion device, and is, for example, a lens, a shutter, or a mirror. The control device CTRL controls the photoelectric conversion device APR, and is, for example, a semiconductor device such as an ASIC. The processing device PRCS processes a signal output from the photoelectric conversion device APR and constitutes an analog front end (AFE) or a digital front end (DFE). The processing unit PRCS is a semiconductor device such as a central processing unit (CPU) or an ASIC. The display device DSPL may be an electroluminescent (EL) display device or a liquid crystal display device that displays information (image) obtained by the photoelectric conversion device APR. The storage device MMRY may be a magnetic device or a semiconductor device that stores information (image) obtained by the photoelectric conversion device APR. The storage device MMRY may be a volatile memory such as an SRAM or a DRAM, or a nonvolatile memory such as a flash memory or a hard disk drive. The mechanical device MCHN may include a movable portion or a propulsion portion such as a motor or an engine. In the equipment EQP, a signal output from the photoelectric conversion device APR is displayed on the display device DSPL or transmitted to the outside by a communication device (not illustrated) included in the equipment EQP. Therefore, it is preferable that the equipment EQP further includes a storage device MMRY and a processing device PRCS separately from the storage circuit unit and the arithmetic circuit unit included in the photoelectric conversion device APR.

The equipment EQP illustrated in FIG. 37 may be an electronic device such as an information terminal having a photographing function (for example, a smartphone or a wearable terminal) or a camera (for example, an interchangeable lens camera, a compact camera, a video camera, or a monitoring camera.). The mechanical device MCHN in the camera may drive components of the optical device OPT for zooming, focusing, and shutter operation. The equipment EQP may be a transportation device (movable object), such as a vehicle, a ship, or an airplane. The equipment EQP may be a medical device such as an endoscope or a CT scanner.

The mechanical device MCHN in the transport device may be used as a mobile device. The equipment EQP as a transport device is suitable for transporting the photoelectric conversion device APR, or for assisting and/or automating operation (manipulation) by an imaging function. The processing device PRCS for assisting and/or automating driving (manipulation) may perform processing for operating the mechanical device MCHN as a moving device based on information obtained by the photoelectric conversion device APR.

The photoelectric conversion device APR according to the present embodiment may provide a high value to a designer, a manufacturer, a seller, a purchaser, and/or a user thereof. Therefore, when the photoelectric conversion device APR is mounted on the equipment EQP, the value of the equipment EQP may also be increased. Therefore, in manufacturing and selling the equipment EQP, it is advantageous to determine the mounting of the photoelectric conversion device APR of the present embodiment on the equipment EQP in order to increase the value of the equipment EQP.

### Modified Embodiments

The present disclosure is not limited to the above embodiments, and various modifications are possible.

For example, an example in which a part of the configuration of any of the embodiments is added to another embodiment or an example in which a part of the configuration of any of the embodiments is substituted with some of the configurations of another embodiment is also an embodiment of the present disclosure.

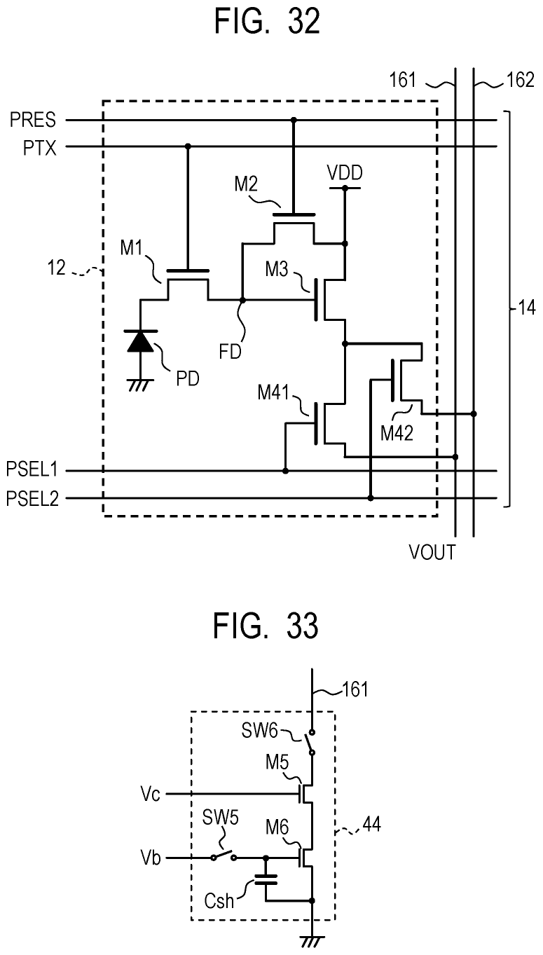

The circuit configuration of the pixel 12 illustrated in FIG. 2 is an example and may be appropriately changed. For example, as illustrated in FIG. 32, drains of two select transistors M41 and M42 may be connected to the source of the amplifier transistor M3, the signal line 161 may be connected to a source of the select transistor M41, and the signal line 162 may be connected to a source of the select transistor M42. Each of the pixels 12 may include two or more photoelectric conversion elements. In this case, a plurality of photoelectric conversion elements may share one FD node. Alternatively, a pupil division pixel in which a plurality of photoelectric conversion elements shares one microlens may be used so that a phase difference may be detected. In addition, the pixel 12 does not necessarily have to include the select transistor M4. The capacitance value of the node FD may be switchable.

The current source circuits 441 and 442 are not limited to the configurations illustrated in FIG. 3 and FIG. 4, and various modifications are possible. For example, as illustrated in FIG. 33, a sample-and-hold circuit including a capacitor Csh connected between the gate and the source of the transistor M6 and a switch SW5 connected between a node of the voltage Vb and the gate of the transistor M6 may be added to the current source circuit 44. By holding the voltage Vb in the capacitor Csh, the source-gate voltage of the transistor M6 may be easily maintained even when the ground voltage fluctuates, and current fluctuation may be suppressed. A switch SW6 for switching a connection state between the signal line 161 and the like and the drain of the transistor M5 may be further added.

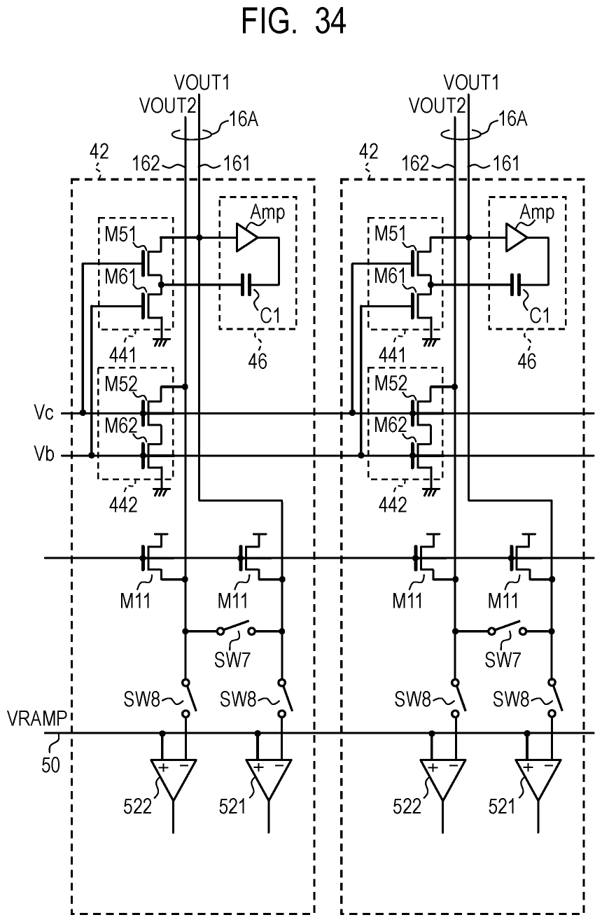

The column circuit 42 is not limited to the configuration illustrated in FIG. 3 and may be modified as appropriate. For example, as illustrated in FIG. 34, transistors M11 that limit the lower limit of the potential of the signal lines 161 and 162 may be provided. This makes it possible to suppress current fluctuations in the current source circuits 441 and 442. Further, a switch SW7 for controlling an electrical connection state (conduction or non-conduction) between the adjacent signal lines 161 and 162 may be provided. Further, switches SW8 for controlling an electrical connection state (conduction or non-conduction) between the signal lines 161 and 162 and subsequent stage circuits (for example, the comparison circuits 521 and 522) may be provided.

Further, in the above-described embodiment, the example in which the slope-type AD conversion circuit is used for the AD conversion of the pixel signal has been described, but the AD conversion circuit used for the AD conversion of the pixel signal is not limited to the slope-type AD conversion circuit. In addition to the slope-type AD conversion circuit, for example, a successive approximation register (SAR) type AD conversion circuit, a delta-sigma-type AD conversion circuit, a pipeline-type AD conversion circuit, or the like may be applied to the AD conversion of the pixel signal.

The photoelectric conversion systems described in the tenth, eleventh and twelfth embodiments are examples of photoelectric conversion systems to which the photoelectric conversion device of the present disclosure may be applied, and the photoelectric conversion system to which the photoelectric conversion device of the present disclosure may be applied is not limited to the configuration illustrated in FIG. 35 and FIG. 36A.

According to the present disclosure, in a photoelectric conversion device including a plurality of signal lines arranged corresponding to pixels in one column, it is possible to reduce the influence of parasitic capacitance accompanied by the signal lines.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)TM), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

The present disclosure is not limited to the above embodiments, and various modifications and variations are possible without departing from the spirit and scope of the present disclosure. Accordingly, the following claims are to be accorded the full scope of the disclosure.

1. A photoelectric conversion device comprising:
a plurality of pixels arranged to form a column and each configured to output a signal based on charge generated by a photoelectric conversion unit;
a plurality of signal lines provided corresponding to the column and each connected to at least one of the plurality of pixels; and
a column circuit connected to the plurality of signal lines,
wherein the plurality of signal lines includes a first signal line and a second signal line, wherein a first capacitance value of a parasitic capacitance associated with the first signal line is greater than a second capacitance value of a parasitic capacitance associated with the second signal line, and
wherein the column circuit includes a speed-up circuit that promotes a change in a potential of the first signal line so as to reduce a difference between a settling time of the potential of the first signal line and a settling time of a potential of the second signal line caused by a difference between the first capacitance value and the second capacitance value.

2. The photoelectric conversion device according to claim 1, further comprising:
a plurality of current source circuit provided corresponding to the plurality of signal lines and each supplying a current to the pixels connected to a corresponding signal line.

3. The photoelectric conversion device according to claim 2, wherein the speed-up circuit includes a first negative capacitance circuit connected to the first signal line.

4. The photoelectric conversion device according to claim 3,
wherein each of the plurality of current source circuits includes a first transistor having a first main node connected to the corresponding signal line, and
wherein the first negative capacitance circuit is connected between the first main node and a second main node of the first transistor of a current source circuit connected to the first signal line.

5. The photoelectric conversion device according to claim 4, wherein the first negative capacitance circuit includes an amplifier having an input node connected to the first main node of the first transistor and a capacitor having one terminal connected to an output node of the amplifier and other terminal connected to the second main node of the first transistor.

6. The photoelectric conversion device according to claim 5, wherein the amplifier is configured to be capable of switching a gain.

7. The photoelectric conversion device according to claim 4, wherein the first negative capacitance circuit is configured to be separable from a current source circuit connected to the first signal line and the first signal line.

8. The photoelectric conversion device according to claim 2,
wherein the speed-up circuit includes an interconnection arranged adjacent to and in parallel with the first signal line, and
wherein a current source circuit connected to the first signal line includes a first transistor having a first main node connected to the first signal line and a second main node connected to the interconnection.

9. The photoelectric conversion device according to claim 4,
wherein each of the plurality of current source circuits further includes a second transistor connected between the second main node of the first transistor and a fixed voltage node, and
wherein the second transistor is a current source transistor, and the first transistor is a cascode transistor.

10. The photoelectric conversion device according to claim 4,
wherein each of the plurality of current source circuits further includes a resistor connected between the first transistor and a fixed voltage node, and
wherein the first transistor is a current source transistor.

11. The photoelectric conversion device according to claim 2, wherein the speed-up circuit includes a current source configured to be connectable to the first signal line and temporarily connected to the first signal line when a potential of the first signal line

12. The photoelectric conversion device according to claim 3, wherein the speed-up circuit further includes a second negative capacitance circuit connected to the second signal line and indicating a negative capacitance value different from that of the first negative capacitance circuit.

13. The photoelectric conversion device according to claim 3,
wherein the plurality of signal lines further includes a third signal line, and
wherein the speed-up circuit further includes a second negative capacitance circuit connected to the third signal line.

14. The photoelectric conversion device according to claim 1, wherein the speed-up circuit is provided corresponding to a signal line arranged at a side end of the plurality of signal lines.

15. The photoelectric conversion device according to claim 1, further comprising:
a first substrate provided with the plurality of pixels; and
a second substrate stacked on the first substrate and provided with the column circuit.

16. The photoelectric conversion device according to claim 15, wherein each of the plurality of signal lines is divided into a first portion and a second portion arranged on the first substrate and a third portion arranged on the second substrate.

17. The photoelectric conversion device according to claim 1, wherein the column circuit includes a first analog-to-digital conversion circuit configured to covert the signal of the pixel output via the first signal line into a digital signal, and a second analog-to-digital conversion circuit configured to convert the signal of the pixel output via the second signal line into a digital signal.

18. A photoelectric conversion system comprising:
the photoelectric conversion device according to claim 1; and
a signal processing device configured to process a signal output from the photoelectric conversion device.

19. A movable object comprising:
the photoelectric conversion device according to claim 1;
a distance information acquisition unit configured to acquire distance information to an object from a parallax image based on a signal from the photoelectric conversion device; and
a control unit configured to control the movable object based on the distance information.

20. An equipment comprising:
the photoelectric conversion device according to claim 1; and
at least one of
an optical device corresponding to the photoelectric conversion device,
a control device configured to control the photoelectric conversion device,
a processing device configured to process a signal output from the photoelectric conversion device,
a mechanical device that is controlled based on information obtained by the photoelectric conversion device,
a display device configured to display information obtained by the photoelectric conversion device, and
a storage device configured to store information obtained by the photoelectric conversion device.
